(19) United States
(12) Patent Application Publication
(10) Pub. No.: US 2023/0134118 A1
(43) Pub. Date: May 4, 2023

(54) DECENTRALIZED SOCIAL NEWS NETWORK WEBSITE APPLICATION (DAPPLICATION) ON A BLOCKCHAIN INCLUDING A NEWSFEED, NFT MARKETPLACE, AND A CONTENT MODERATION PROCESS FOR VETTED CONTENT PROVIDERS

(71) Applicant: George J. Sehremelis, Long Beach, CA (US)

(72) Inventor: George J. Sehremelis, Long Beach, CA (US)

(21) Appl. No.: 18/046,870

(22) Filed: Oct. 14, 2022

Related U.S. Application Data
(60) Provisional application No. 63/256,493, filed on Oct. 15, 2021.
(60) Provisional application No. 63/321,543, filed on Mar. 18, 2022.

(51) Int. Cl. G06F 21/64; G06Q 20/36; G06Q 50/00

(52) U.S. Cl. CPC G06F 21/64; G06Q 20/3672; G06Q 50/01; G06Q 2220/00

(57) ABSTRACT

A decentralized system for addressing disinformation in news includes a number of nodes connected over a distributed peer-to-peer blockchain-based network, a non-transitory computer-readable storage medium of at least one node having software instructions stored therein, which, when executed by a processor of the at least one node, cause the processor to display, on a display of an electronic device, a newsfeed comprising a number of news items received from one or more publishers, and moderate the content displayed on the display of the electronic device in response to a vote by members of a decentralized autonomous organization (DAO) in which the members of the DAO include the one or more publishers.

### CROSS-REFERENCE TO RELATED APPLICATION(S)

The present application claims priority to and the benefit of U.S. Provisional Application No. 63/256,493, filed Oct. 15, 2021, and U.S. Provisional Application No. 63/321,543, filed Mar. 18, 2022, the entire contents of both of which are incorporated herein by reference.

### BACKGROUND

### 1. Field

The present disclosure relates to blockchain-based systems and methods of moderating content on a newsfeed.

### 2. Description of Related Art

In recent years, misinformation (e.g., disinformation) has been on the rise with the widespread use of digital media. Advancements in digital technology have enabled bad actors and/or automated systems (e.g., governments, companies, bots) to spread a form of news including deliberate disinformation or hoaxes (i.e., fake news, disinformation on social media). This form of misinformation tends to damage the subject of the disinformation for financial and/or political gain by using sensationalist, dishonest, or outright fabricated stories, headlines, images, and/or videos. With the rise of social media consumption generally, disinformation has increasingly gone “viral” (e.g., spread rapidly with a number of individuals) and found its way into mainstream media causing widespread harm.

### SUMMARY

The present disclosure relates to various embodiments of a decentralized social news network application (i.e., a dapplication) on a blockchain including a newsfeed, a non-fungible token (NFT) marketplace, and a content moderation process for vetted content providers acting as validators/challengers.

In one embodiment, a decentralized system for addressing disinformation in news includes a number of nodes connected over a distributed peer-to-peer blockchain-based network, a non-transitory computer-readable storage medium of at least one node having software instructions stored therein, which, when executed by a processor of the at least one node, cause the processor to display, on a display of an electronic device, a newsfeed comprising a number of news items received from one or more publishers, and moderate the content displayed on the display of the electronic device in response to a vote by members of a decentralized autonomous organization (DAO) in which the members of the DAO include the one or more publishers, journalists, etc.

In one embodiment, a method for addressing disinformation in news includes displaying, on a display of an electronic device, a newsfeed including a number of news items received from one or more publishers, and moderating the content displayed on the display of the electronic device in response to a vote by members of a decentralized autonomous organization (DAO) in which the members of the DAO include the one or more publishers, journalists, etc.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter.

### BRIEF DESCRIPTION OF THE DRAWINGS

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a block diagram of a system for processing and communicating a data feed according to one embodiment of the present disclosure;

FIG. 2 is a flowchart illustrating tasks of a method of detecting bias in an article according to one embodiment of the present disclosure;

FIG. 3 is a flowchart illustrating tasks of a method of analyzing claims in an article according to one embodiment of the present disclosure;

FIG. 4 is a flowchart illustrating tasks of a method of detecting hate speech in an article according to one embodiment of the present disclosure;

FIG. 5 is a flowchart illustrating tasks of a method of summarizing an article according to one embodiment of the present disclosure;

FIGS. 6 and 7 are screenshots of a data feed of a platform and a feature enabling a business, a network, or other data provider to send “push” web, mobile, and email newsletter notifications to subscribers, respectively, according to one embodiment of the present disclosure;

FIGS. 8A-8F depict screenshots of a website and a mobile application incorporating the algorithms and other functionality of the present disclosure;

FIG. 9 is a flowchart illustrating tasks of a method of generating ethical and actional data from content by applying a predictive algorithm according to one embodiment of the present disclosure;

FIG. 10 is a schematic block diagram of a decentralized application (“dApp”) in which content providers serve as nodes (validators and challengers) in a blockchain network, and a user device in communication with the blockchain and a database server according to one embodiment of the present disclosure;

FIG. 11 is a schematic block diagram of the user device illustrated in FIG. 10, including an electronic wallet;

FIG. 12 is a schematic block diagram of the blockchain depicted in FIG. 10, including the dApp connected to the proof of stake blockchain, challengers/validators (content moderation incentivization of truth), a smart contract module, the database server, and the user device;

FIG. 13 is a schematic view of a decentralized (content moderation incentivization of truth) proof of work mining system according to one embodiment of the present disclosure; and

FIGS. 14A-14B are screenshots of a text editor and a drafts feature to send web mobile and newsletter push notifications, respectively, and according to one embodiment of the present disclosure.

### DETAILED DESCRIPTION

The present disclosure is directed to various embodiments of systems and methods for a closed social networking platform including a data architecture that has a finite number of options or choices to reduce the spread of disinformation between one or more users, media broadcasts, videos, news articles, etc. In one or more embodiments, the systems and methods of the present disclosure are configured to move towards a net zero of digital disinformation through a closed social news network operating in conjunction with an open-source decentralized application ‘bridged’ to the blockchain (e.g., a process of moving content on a blockchain, where vetted content moderators use systems (i.e., a forcing function) to get rewarded for moderating and verifying the content on each block). That is, the systems and methods of the present disclosure include a Web2 database connected (i.e., bridged) to a Web3 blockchain to moderate content on a newsfeed. The moderation may be performed by vetted publishers and/or content creators serving as validators/challengers to the content, and the vetted publishers and/or the validators/challengers may vote as part of a decentralized autonomous organization (DAO) to moderate the content. Validators and challengers may connect to each block through the platform through self-executing code (e.g., a smart contract) so when the content meets certain conditions it can be added to the chain and be verified by a network of decentralized journalists or minted to the platform chain. The systems and methods of the present disclosure may include rewarding moderation (i.e., fact-checking content) with platform coin. In this manner, the systems and methods of the present disclosure, which reward vetted journalists who moderate content on the decentralized system, moderate content more efficiently and accurately than conventional means by incentivizing the monetization of the truth instead of disinformation. The content moderation may occur on the Web2 database prior to storing the content on the blockchain, or the content moderation may be performed on the proof of stake and/or proof of work blockchain. The platform blockchain(s) may be proof of stake, proof of work, a combination of the two, or both independent and connected to one another in different ways. Content providers, including validators and challengers (e.g., publishers, journalists, vetted creators, etc.) may pay the platform to stake their content on chain through holding a balance of cryptocurrency/currency (i.e., the forcing function forces a content provider to hold cryptocurrency/currency/assets in an account to be used for security and verification reasons). The more the content provider stakes, the better of a validator the content provider is, which means the next time a block of content needs to be validated, the content provider will have a higher chance of being able to validate based on the amount staked. The decision-making processes for challengers and validators may be expressed in the platform whitepaper and via a DAO. There may be consensus algorithms involving sentiment analysis or search via topic, text, time, details, or any spectrum among other types of consensus algorithms across the Web2 database to help identify consensus or ‘ground truth’ to make the content moderation process more efficient and effective. The systems and methods of the present disclosure include providing a data feed including content such as media broadcasts, videos, and/or news articles, etc. where users are limited to a finite set of options (e.g., commenting and/or “liking”) and are unable to take any action that impacts the data feed such as publishing content to the data feed or altering the published content on the data feed, unless previously verified or otherwise authorized (e.g., vetted or screened). The finite set of options reduces the number of interactions for review and categorization of the interactions based on reduced variability and increased predictability. The systems and method of the present disclosure may include one or more data algorithms processing content on the data feed and/or interactions. In one or more embodiments, the data algorithms including a bias detection method, a claim detection method, a hate speech detection method, a summarizer, and other digital media content-related algorithms, such as predictive algorithms, consensus algorithms to assist with the challenger/validation content moderation process, staking or rewards-based algorithms, halving algorithms, among other things. These algorithms and methodologies may be applied to, or incorporated in, any suitable system or platform (e.g., these algorithms and methodologies may be incorporated into a third-party platform).

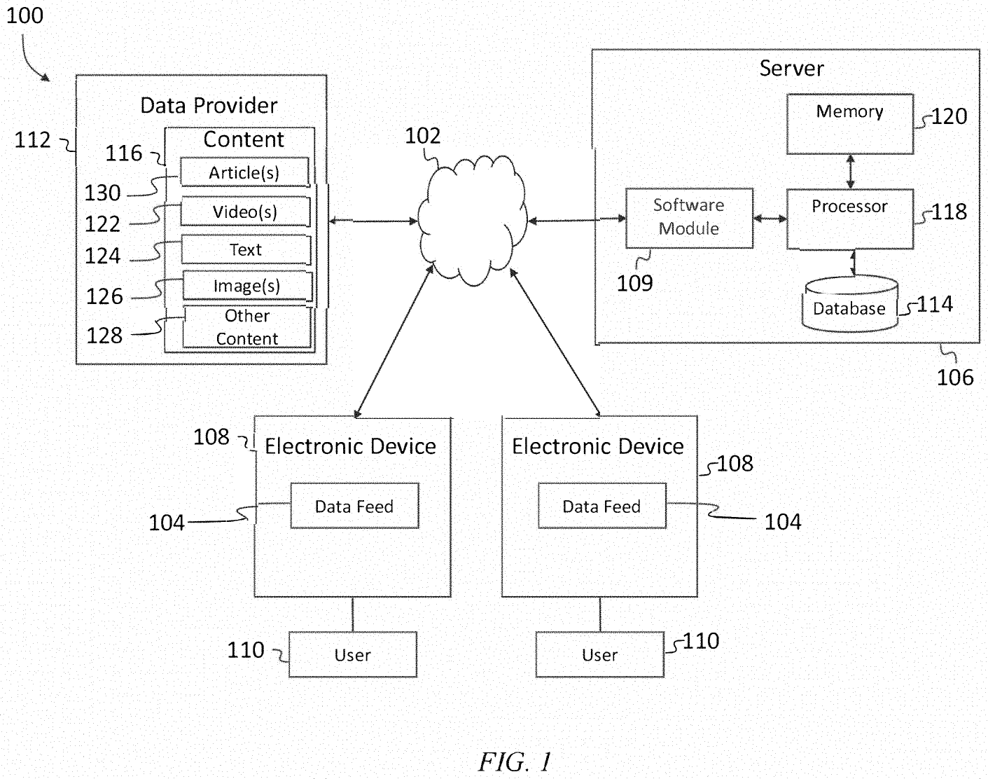

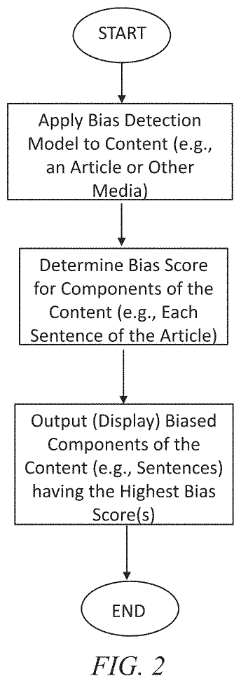

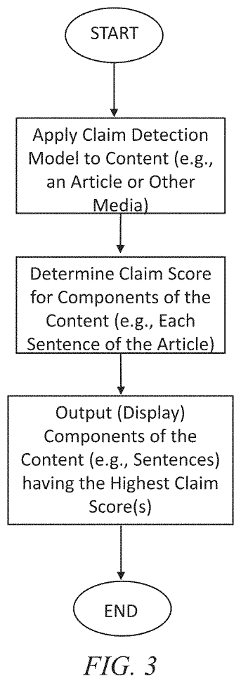

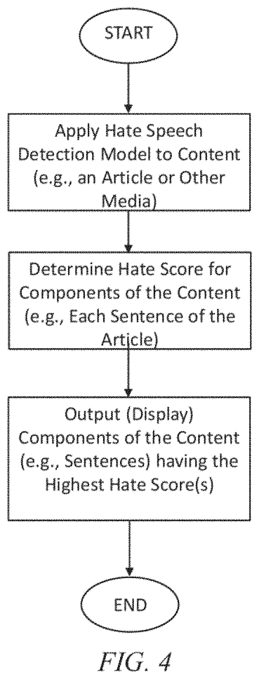

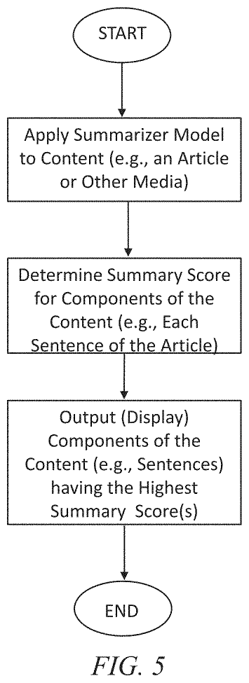

FIG. 1 is a block diagram of a system 100 for processing and communicating a data newsfeed (or a set of newsfeeds) 104 over a data network 102 according to one embodiment of the present disclosure. The system 100 includes a server 106, one or more electronic devices 108 operated by one or more corresponding users 110, and a data provider 112. The one or more users may be participants in the system 100 for processing and communicating a data feed 104 that combats or reduces disinformation. In one or more embodiments, the newsfeed(s) 104 may be algorithmically designed not to recommend and/or display content based on user engagement with content on the newsfeed(s) 104, which might otherwise tend to expose the user to limited topics and/or limited perspectives (e.g., an “information bubble” or “echo chamber”). The one or more users may operate the electronic devices 108 to view and interact with the data feed 104. The number of electronic devices 108 and users 110 may vary according to the design of the server 106 and the system 100, and are not limited to the number illustrated in FIG. 1.

In one or more embodiments, the server 106 is connected to (i.e., in electronic communication with) a plurality of electronic devices 108 over a data network 102 such as, for example, a local area network or a wide area network (e.g., a public Internet, a virtual private network (VPN), or a satellite network such as Starlink™). In one or more embodiments, the system 100 may be connected to (or be a part of) a series of decentralized Internet Service Providers (decentralized ISPs) to ensure that the social news network and the internet network persist and may not be shut off by a hostile takeover. The decentralized ISPs may be pre-vetted nodes or challengers/validators on the network and may include publishers, creators, and businesses, among other things. The server 106 includes one or more software modules 109 for coordinating communications and interactions between the users 110, determining the data feed 104, and applying one or more algorithms directed toward bias detection, hate speech detection, article summarization, and claim checking, among other features, data processes, content related algorithms, or consensus algorithms directed toward combating disinformation on social media through the content moderation process. The algorithms will be described in more detail below.

In one or more embodiments, the server 106 includes a mass storage device or database 114 such as, for example, a disk drive, drive array, flash memory, magnetic tape, or other suitable mass storage device for storing information used by the server 106. For example, the database 114 may store personal profile information (e.g., a “handle”) about the users 110, interactions between the users 110, interactions between a user and a corresponding data feed 104, business/network data, content 116 from a data provider 112, and/or analysis results (e.g., preprocessed data) based on a bias detection method, a claim detection method, a hate speech detection method, an article summarization method, and/or other digital media content related algorithms, among other things. In one or more embodiments, the database may store any other relevant information for facilitating interactions between users 110, determining a data feed 104, and providing a data feed 104. Although the database 114 is included in the server 106 as illustrated in FIG. 1, in one or more embodiments, the server 106 may be connected to an external database that is not a part of the server 106, in which case, the database 114 may be used in addition to the external database or be omitted entirely.

The server 106 further includes a processor or central processing unit (CPU) 118, which executes program instructions from memory 120 and interacts with other system components to perform various methods and operations according to one or more embodiments of the present invention. The memory 120 is implemented using any suitable memory device, such as a random access memory (RAM), and may additionally operate as a computer-readable storage medium having non-transitory computer readable instructions stored therein that when executed by a processor cause the processor to control and manage interactions and facilitate communications between users 110 using corresponding electronic devices 108, data providers 112 providing content 116, analysis of content 116, and/or a data feed 104 over the data network 102.

The term “processor” is used herein to include any combination of hardware, firmware, and software, employed to process data or digital signals. The hardware of a processor may include, for example, application specific integrated circuits (ASICs), general purpose or special purpose central processors (CPUs), Quantum Processing Unit (QPU), Decentralized CPU (DCPU), digital signal processors (DSPs), graphics processors (GPUs), and programmable logic devices such as field programmable gate arrays (FPGAs). In a processor, as used herein, each function is performed either by hardware configured, i.e., hard-wired, to perform that function, or by more general purpose hardware, such as a CPU, configured to execute instructions stored in a non-transitory storage medium. A processor may be fabricated on a single printed wiring board (PWB) or distributed over several interconnected PWBs. A processor may contain other processors, for example, a processor may include two processors, an FPGA and a CPU, interconnected on a PWB.

According to some embodiments of the present invention, the electronic devices 108 may connect to the data communications network 112 using a telephone connection, satellite connection, cable connection, radio frequency communication, or any suitable wired or wireless data communication mechanism. To this end, the electronic devices 108 may take the form of, for example, a personal computer (PC), hand-held personal computer (HPC), personal digital assistant (PDA), tablet or touch screen computer system, telephone, satellite network, an application specific integrated circuit (ASIC), smart contact lens, brain-machine interface (BMI) device, cellular telephone, smartphone, an augmented reality system, a virtual reality system, an autonomous vehicle, or any suitable consumer electronics device.

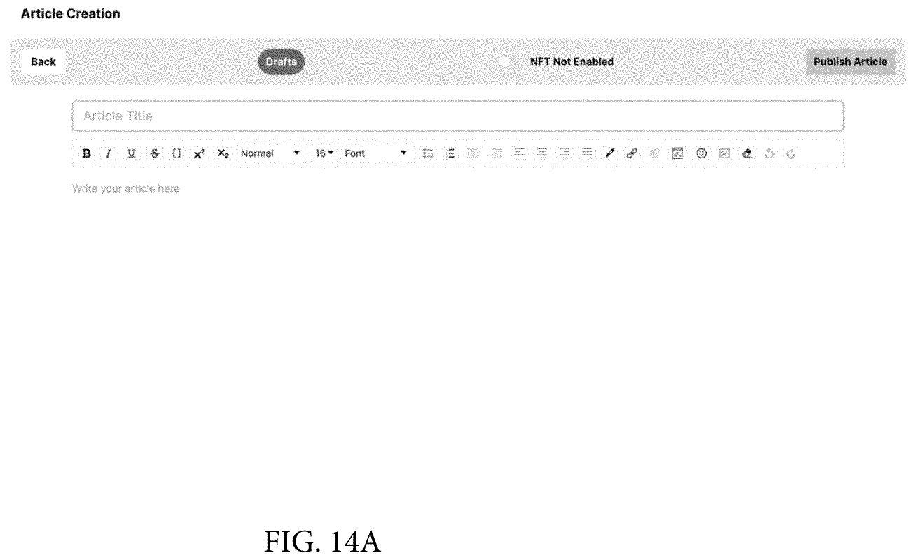

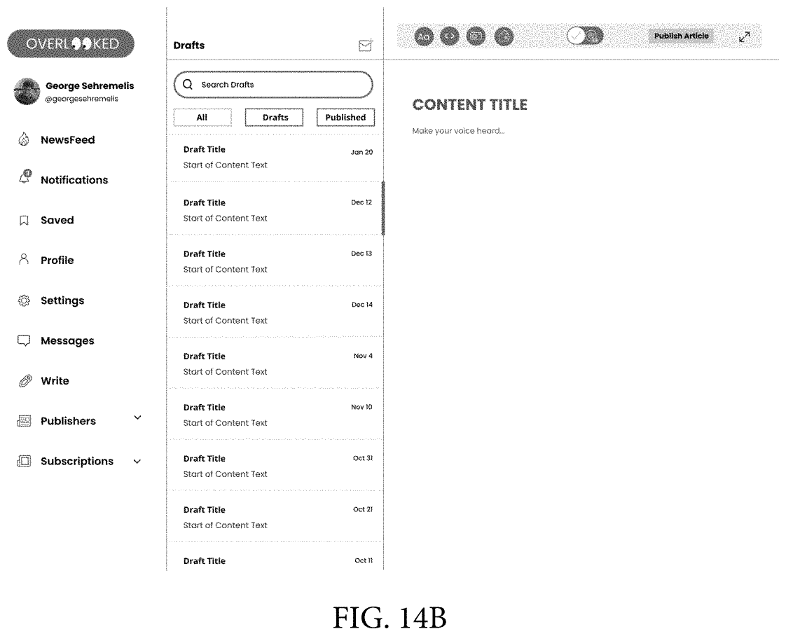

In one or more embodiments, a data provider 112 publishes one or more items of content 116 including an article 130, a video 122, text 124, an image 126, and/or any other suitable content 128 (e.g., links to other articles, email newsletters, citations, metadata, and any other suitable elements in a piece or item of content). The data provider 112 may transmit or submit the one or more items of content 116 to the server 106 for processing. In one or more embodiments, the server 106 extracts or scrapes the one or more items of content 116 from the website hosting the one or more items of content 116 (e.g., via web scraping, web harvesting, web data extraction, RSS feed data, etc.). In one or more embodiments, the content may be written through a text editor (shown in FIG. 14) and be published for verification on the website.

The server 106 may aggregate one or more items of content 116 from multiple data providers 112 and determine which items of content (e.g., news articles, newsletters, media broadcasts, podcasts, radio, or other news content) are desirable for a data feed 104 that may be provided to one or more users 110 through one or more electronic devices 108. In some embodiments, the server 106 provides multiple data feeds 104 that are different from each other to each electronic device 108, and, in some embodiments, the server 106 provides a single shared data feed to multiple electronic devices 108. The data feed 104 includes broadcasts, videos, articles, newsletters, blogs, podcasts, radio, messages, images, and/or other suitable communication media content for viewing by one or more users 110. In one or more embodiments, the content of the data feed 104 is only from data providers 112 having reliable journalism credentials such as articles sourced by local, university, government, national, or international news organizations among other sections of content (e.g., a white list of news organizations). Users may search publishers, other users, generic queries, or content, which may be based on topic to access information specific to a query. In one or more embodiments, one or more items of content 116 are cross-referenced to determine credibility for inclusion in the data feed 104.

Accordingly, the content of the data feed 104 (e.g., primary newsfeed) is determined solely by the server 106 and users 110 do not have the option to take any action that would impact the data feed 104 (or a particular data feed, such as the primary/trending data feed (e.g., newsfeed) such as publishing their own content or otherwise modifying the content of the data feed 104, unless previously verified as a content provider or otherwise authorized (e.g., vetted or screened). That is, in one or more embodiments, the data feed 104 is a closed system that cannot be modified by the user, other than by the user subscribing to receive push notifications for articles or newsletters, among other content from particular news organizations or content providers (e.g., the data feed 104 may be customized or filtered to display data only from a select number or sub-set of the authorized data providers 112). Due to this architecture, data provided to the users 110 is drastically limited which enables journalists, moderators, and algorithmic processes to effectively manage or monitor the content of the data feed 104 (i.e., the amount of content displayed on the data feed 104 is drastically reduced compared to an “open” system in which user can post their own content, such as articles, pictures, and videos, which enables effective moderation of the content on the data feed 104 and combats the threat of deep fakes or other data manipulation by outside software, bots, and actors). In one or more embodiments, data algorithms and other processes may be used to identify and eradicate the aforementioned types of content manipulation. Journalists and moderators may more easily identify inaccurate media content prior to and after publishing the data feed 104 compared to an “open” system in which users are freely able to post content (e.g., articles, videos, images) without being previously vetted, screened, or verified. Additionally, a user may be “push” notified if an article among other content they viewed was proven via a fact check to be disinformation.

In some embodiments, the journalists and moderators may be live humans assisted by automated or semi-automated systems including algorithms detecting bias, hate speech, reliable claims, unreliable claims, inaccurate or misleading claims, other content related algorithms, and/or any other suitable functions. As described in more detail below, content moderation may be decentralized to local publishers outlined in a White Paper and made possible through a feature on the platform. In some embodiments, the functions performed by journalists and moderators are performed by automated systems.

In one or more embodiments, the system 100 provides the data feed 104 including content such as media broadcasts, videos, newsletters, podcasts, radio, news articles, and/or any other web-based content for viewing by one or more users 110. The data feed 104 may present a variety of content that may be prepared, reviewed, and/or selected by the server 106. However, a user 110 viewing the data feed 104 is presented with a finite set of options. In one or more embodiments, users are unable to take any action that impacts the data feed such as publishing their own articles or content as part of the data feed, unless previously verified as a content provider or otherwise authorized (e.g., vetted or screened). For example, a user may be limited to expressing approval (e.g., “like”) a portion (e.g., articles, images, videos, etc.) of the data feed 104, comment on a portion of the data feed 104, play a video or translated audio version of the data feed (e.g., “watch” or “listen”), message (e.g., “DM”), experience immersive content (e.g., content in an omniverse or a metaverse), vote on a portion of the data feed 104 (e.g., rating an article based on any relevant factor, such as bias, trustworthiness, and/or relevancy), and/or ping (e.g., “share” with) another user, group, or audience with respect to a portion of the data feed 104 as part of the finite set of options provided to the users 110. In one or more embodiments, the users 110 options are not limited to “liking”, “sharing”, voting or rating, watching or playing, experiencing, and/or commenting on portions of the data feed 104. Furthermore, in one or more embodiments, users may be able to share news articles, broadcasts, and/or other media content to their “stories.” In one or more embodiments, users may be able to view who has ‘seen’ their shared content via sharing, messaging, and ‘stories’. However, in one or more embodiments, the software module 109 does not permit user-generated content (e.g., user-generated articles) to be posted to the “stories,” unless previously verified as a content provider or otherwise authorized (e.g., vetted or screened), although small snippets of text, images, video, or audio may be permitted to be written or posted next to the verified content in the “stories.” The stories may be public or private. In one or more embodiments, public or private stories may be shared publicly or privately (e.g., a private story may be shared privately with a VIP list of friends/subscribers, and a public story may be shared with everyone). Furthermore, in one or more embodiments, multiple private lists of VIP access may be created for sharing stories. In one or more embodiments, the software module 109 is configured to enable users to have a personal profile that includes their contact information and relevant links to other platforms, among other things. Additionally, in one or more embodiments, the software module 109 may enable users to message each other.

In one or more embodiments, “sharing” a portion of the data feed 104 (e.g., an article, video, and/or media broadcast) may further include “group sharing.” For example, a user may form a group comprising a plurality of users (e.g., a group of friends) by inviting others users to join or form a group. Each group may have one or more users with administration privileges. Administration privileges allow a user to “share” to the entire group (i.e. “group share”) a portion of the data feed 104. For example, a user with administrative privileges may “group share” to their group a news article among other things (e.g., a journalism lecture) presented by the data feed 104 and all of the members within the group may receive a “push” notification (e.g., a link or notification that a user may click or push to access set content) from the server 106. In one or more embodiments, users with certain administration privileges will be able to see whether or not members within their group read or viewed the content sent via “group share.” In one or more embodiments, once content (e.g., an article) is shared with a friend or a group of friends, users will be able to message each other about the shared article. In one or more embodiments, users will be able to message or notify their friends on the platform about a piece of content (e.g., an article, video, press release, etc.) without first sharing the content. Furthermore, in one or more embodiments, a user or data provider with administration privileges may be able to post to a “group story.” The group story may be public or private. In one or more embodiments, public or private group stories may be shared publicly or privately (e.g., a private group story may be shared privately with a VIP list of friends/subscribers, and a public group story may be shared with everyone). Furthermore, in one or more embodiments, multiple private lists of VIP access may be created for sharing group stories among other content. In one or more embodiments, the features and functionality available to users with administrative privileges in a group may be the same as the features and functionality available to users not in a group, except the features and functionality available to users with administrative privileges in a group may be targeted only to those users in the group (e.g., messaging, sharing, and/or posting stories only to other group members). The present disclosure is not limited to the manner of sharing articles or other data described above, and in one or more embodiments, articles or other data may be shared by users and/or data providers in any other suitable manner.

In one or more embodiments, the server 106 sends “push” notifications when an article among other content is “shared” or “group shared” by another user, when another user “likes” or replies to a comment belonging to the user, when an email newsletter is sent to a content provider's subscribers, and/or when a significant newsworthy event occurs among other reasons. “Push” notifications are sent to the subscribers of the publications on the platform from the administrator of a publication's “page” and/or the platform and may hyperlink to a news article, video, podcast, radio, or media broadcast, among other types of news content. “Push” notifications may also be sent by the server 106 when bias, hate speech, reliable claims, unreliable claims, inaccurate or misleading claims, and/or any other suitable characteristics are later identified after a user has viewed the portion of the data feed 104. Accordingly, a user may receive an update regarding portions of the data feed 104 that the user previously viewed. These “push” notifications may be sent to the friends/subscribers of specific users, to the subscribers of a group of users that made a page, to the subscribers of particular networks, to subscribers of specific business pages, and/or to subscribers of verified journalists, publishers, media relations entities, industry professionals and experts (described below), among other things. Moreover, these “push” notifications may target a private or public group of users with any piece of content or data that provides value (e.g., email newsletters, a VIP list of subscribers, or multiple private lists of VIP access).

In one or more embodiments, neural network algorithms directed toward bias detection, hate speech detection, and/or claim detection may be applied by the server 106 as directed by the software module 109. For example, the software module 109 may manage a request from a user 110 or a data provider 112 to apply one or more algorithms. In response, the processor 118 of the server may execute instructions in the memory 120 corresponding to the request algorithms.

In one or more embodiments, the bias detection, hate speech detection, and/or claim detection employs word-level, sentence-level, and article-level analyses to judge the overall characteristics of a portion of the data feed 104 to determine whether it is likely to contain some bias, questionable claims, and hateful statements. In one or more embodiments, the bias detection, hate speech detection, and/or claim detection algorithms learn from the wording of each sentence and from how sentences are contextually embedded in the portion of the data feed 104. The algorithms then specialize in capturing distinctive features that render the portion of the data feed 104 subjective. The algorithms may then provide an overall evaluation by performing sentence level analysis by backtracking the impact of each sentence on overall score to identify which sentences are most likely to cause the portion of the data feed 104 to be biased, hateful, reliable, unreliable, and/or factually inaccurate. In one or more embodiments, these sentences are provided to the users 110.

In one or more embodiments, the bias detection method includes applying a bias detection model to a selected portion of a data feed 104 (e.g., an article). The bias detection model may be trained based on preprocessing data and may be updated or retrained periodically.

In one or more embodiments, data for preprocessing is extracted from the database 114 and/or an external database. The data includes a dataset having text that has been reviewed and labeled for objectivity and/or bias. For example, a dataset may include one or more articles, videos, or media content (or reviewed text) where each article or item of content has been independently reviewed and labeled as having a determined degree of objectivity and/or degree of bias.

In one or more embodiments, preprocessing includes acquiring vector representations for each word in an individual piece of content (e.g., an article or video) in the dataset according to any suitable technique known in the art, for example, a technique for acquiring vector representations for words based on pre trained word embeddings is described in an article by Jacob Devlin, Ming-Wei Chang, Kenton Lee, Kristina Toutanova titled “BERT: Pre-training of Deep Bidirectional Transformers for Language Understanding” (2018) (last revised May 24, 2019) available at https://arxiv.org/pdf/1810.04805.pdf, the entire content of which is incorporated herein by reference.

In one or more embodiments, preprocessing further includes splitting an article (or other pieces of content) in the dataset into words and/or sentences to carry out basic natural language processing operations using any suitable technique known in the art, for example, a method of splitting an article into words may be performed using a software library for advanced natural language processing capable of tokenizing text and other various functions.

After splitting a piece of content (e.g., an article) of the dataset into words and/or sentences, the emotion of the author of the words and/or sentences may be determined (e.g., on a sliding scale from negative to positive). The attitude or emotion of the author may be measured as a function of polarity and/or subjectivity. Polarity refers to a float in the range of −1 to 1 where 1 is a positive statement and −1 is a negative statement. Subjectivity refers to a float in the range of 0 to 1 where 0 is a factual statement and 1 is a personal opinion, emotion, or judgment. In one or more embodiments, polarity and/or subjectivity are determined according to any suitable technique known in the art. As an example, a method of determining subjectivity and/or polarity may include using any software library for processing textual data which enables common natural language processing tasks such as part-of-speech tagging, noun phrase extraction, sentiment analysis, classification, translation, and more.

In one or more embodiments, the preprocessed data from the dataset is formed into a stack including the source text, vector representation of the source text, subjectivity, and polarity. The stack formed from preprocessed data may be used to create a dictionary for the various features of each article (or reviewed text), and the dictionary may be appended to the preprocessed data in a database (e.g., database 114 and/or an external database) for future access. In this manner, the dictionary may be quickly consulted without having to preprocess the dataset again.

In one or more embodiments, preprocessing includes processing the text of the body of an article and the text of a title (e.g., an article headline) of the article as separate categories with both the title and the body relating to a single article. Therefore, comparisons may be made between the title and the body of the article as discussed in more detail below.

Accordingly, several features are determined, stacked, and returned to the bias detection model (e.g., the main overall program or system that calls the various functions and receives data from those functions) by various preprocessing functions for modularity (i.e., each function is a separate module and gets the input, carries out its processing and returns the processed output to the main running program).

In one or more embodiments, the preprocessed data (e.g., data including the dictionary) in the database is consulted or extracted to train the bias detection model. The preprocessed data may include any number of media related content, for example, a single article or thousands of articles and/or videos, broadcasts, etc. The preprocessed data may be used as training data where the preprocessed data is fed into a main training loop. During the training loop, padding may be carried out on the training loop to make it uniform prior to feeding the padded data through a custom loader that creates batches on which training can be carried out.

In one or more embodiments, training includes using a linear attention class. The linear attention class is configured to calculate the weighted vector summation according to the attention weight that each sentence pays to the title vector.

In one or more embodiments, training includes using a first convolutional neural network (“CNN”) class (e.g., a time distributed CNN class) and a second CNN class. The first CNN class is configured to combine the separate word level vectors into sentence level vectors by applying various filters to the input data. In one or more embodiments, the first CNN class only operates on the vector representations. In other words, in one or more embodiments, the polarity and the subjectivity are not processed by the first CNN class. The second CNN class is configured to combine polarity and subjectivity from word level to sentence level. Accordingly, using the first CNN class and the second CNN class on the preprocessed data results in each sentence of the preprocessed data having a vector representation.

In one or more embodiments, training includes using a main model class CNN to combine sentence vectors into final vectors for classification. The main model class CNN calls on the attention class for calculating global attention with respect to the title vector. The forward function then passes the sentence vector into the main model class CNN architecture. The output of the main model class CNN is then concatenated with the reduced global attention vector, and the sentence level polarity and subjectivity. This is passed through a sigmoid and a bias score (e.g., a probability score) is determined. In one or more embodiments, a lower score indicates more bias while a higher score indicates less bias. In one or more embodiments, the determined bias score is compared to the bias score of a ground truth. The ground truth in this context may refer to bias scores determined based on previous bias detection models and databases comprising articles or other content that have been reviewed and labeled for objectivity and/or bias. The main model class CNN may use cross entropy loss and the bias detection model may be saved after a set number of epochs to improve inference performance. Although “lower score” and “higher score” are used to indicate “more bias” and “less bias” respectively, one of ordinary skill in the art would appreciate that any suitable scoring system may be used to indicate “more bias” or “less bias”. For example, in one or more embodiments, a lower score may indicate less bias while a higher score indicates more bias.

In one or more embodiments, the bias detection model loads saved or trained parameters to perform inferencing. During inferencing, preprocessing operations are performed on the test article or other content to convert the article into input vector format. The test article is then fed into the bias detection model to return a separate score for each sentence of the test article. In one or more embodiments, the bias detection model is applied multiple times to modified versions of the test article to identify the impact of each sentence in the test article on the bias score (i.e., the bias detection model is applied recursively). For example, in one or more embodiments, one or more sentences may be removed from the content and reintroduced between successive applications of the bias detection model. Based on the change in the bias score when a sentence is removed compared to when the sentence was present, the importance of the sentence to the bias score may be determined.

In one or more embodiments, the impact of every sentence is measured and, for example, the top fifth of total sentences that had the largest impact on (e.g., largest change in) the bias score may be identified by the server as biased sentences. The biased sentences may be provided (e.g., displayed) to a user viewing the portion of the data feed including the article (or other content, such as a media broadcast) that inferencing is performed on. In one or more embodiments, the sentences having a bias score above a threshold value (e.g., a fixed objective threshold bias score, a bias score in a top percentile (such as the top 20%, the top 15%, or the top 10%) of all of the bias scores of the sentences in the article, video, or other content, or a bias score higher than the next highest bias score by a threshold amount) may be provided (e.g., displayed) to the user.

In one or more embodiments, the claim detection method includes applying a claim detection model to a selected portion of a data feed 104 (e.g., an article, media broadcast, etc.). The claim detection model may be trained based on preprocessing data and may be updated or retrained periodically.

In one or more embodiments, data for preprocessing is extracted from the database 114 and/or an external database. The data includes a dataset having text that has been reviewed and labeled for reliability and/or fakeness. For example, a dataset may include one or more articles (or reviewed text) where each article has been independently reviewed and labeled as having a determined degree of reliability and/or a degree of fakeness. A portion of or all of the data may be retrieved from a third party fake news corpus (e.g, a publicly available news dataset of articles, videos, or other content that have been reviewed and labeled as fake, reliable, and/or unreliable). In one or more embodiments, the data used for the bias detection method may be used to supplement data from a fake news corpus. Although the data used for bias detection may only include labels for objectivity and subjectivity, in one or more embodiments, given the data is from reliable data providers, and therefore, the data may be labeled as reliable for the purposes of the claim detection method.

In one or more embodiments, preprocessing for the claim detection method is similar to the preprocessing for the bias detection method. For example, the preprocessing for the claim detection method includes the same functions as the bias detection method in addition to some additional functions directed toward reliability and/or fakeness. Additional functions may include requesting articles or other media content from a fake news corpus having a specified label (e.g., fake, reliable, and/or unreliable) and loading data from the fake news corpus with the fake, reliable, and/or unreliable labels removed for training purposes.

In one or more embodiments, preprocessed data in a database is consulted or extracted to train the claim detection model. The preprocessed data may include any number of articles or other media content, for example, a single article or thousands of articles. The preprocessed data may be used as training data where the preprocessed data is fed into a main training loop. During the training loop, padding may be carried out on the training loop to make it uniform prior to feeding the padded data through a custom loader that creates batches on which training can be carried out. In the case of the claim detection model, padding is carried out in a different manner compared to the bias detection model because a different padding method provides more robust and better results for claim detection. For example, the claim detection model may use articles or other content from the fake news corpus which may be in a tensor format. Therefore, in one or more embodiments, the padding function uses tensor attributes to find out the shapes of the input tensors and perform calculations and padding. In contrast, the bias detection method may not use tensor attributes because the implementation may be a list of vectors in the dictionary. Therefore, padding for the bias detection method may be performed in a different manner compared to the claim detection model.

In one or more embodiments, training for the claim detection model is similar to training for the bias detection model. For example, the training for claim detection model uses a linear attention class, a first CNN, a second CNN, and a main model class CNN as described in the training for the bias detection model with suitable changes to accommodate fake, reliable, and/or unreliable labels. In one or more embodiments, the bias detection model uses objectivity and/or polarity in addition to other suitable features for improved results (e.g., a more robust or accurate model).

Accordingly, the training for the claim detection model may determine a claim score (e.g., a probability score). In one or more embodiments, a lower score indicates that an article or other media content is more “claimy” (e.g., the article requires further verification for accuracy and/or reliability) while a higher score indicates that an article is less “claimy”. In one or more embodiments, the determined claim score is used to categorize the article and is compared to the claim score of a ground truth. The ground truth in this context may refer to claim scores determined based on previous claim detection models and databases comprising articles that have been reviewed and labeled for fakeness, reliability, and/or unreliability. The main model class CNN may use cross entropy loss and the claim detection model may be saved after a set number of epochs to improve inference performance. Although “lower score” and “higher score” are used to indicate “more claimy” and “less claimy” respectively, one of ordinary skill in the art would appreciate that any suitable scoring system may be used to indicate “more claimy” or “less claimy”. For example, in one or more embodiments, a lower score may indicate less “claimy” while a higher score indicates more “claimy”.

In one or more embodiments, the claim detection model performs inferencing in the same manner described as the bias detection model. Therefore, the impact of every sentence may be measured and, for example, the top fifth of total sentences that had the largest impact on (e.g., largest change in) the claim score may be identified by the server as “claimy” sentences. The “claimy” sentences may be provided (e.g., displayed) to a user viewing the portion of the data feed including the text that inferencing is performed on. In one or more embodiments, the sentences having a claim score above a threshold value (e.g., a fixed objective threshold claim score, a claim score in a top percentile (such as the top 20%, the top 15%, or the top 10%) of all of the claim scores of the sentences in the article or other content, or a claim score higher than the next highest claim score by a threshold amount) may be provided (e.g., displayed) to the user.

In one or more embodiments, the hate speech detection method includes applying a hate speech detection model to a selected portion of a data feed 104 (e.g., an article, media broadcast, and/or social media post). The hate speech detection model be trained based on preprocessing data and may be updated or retrained periodically.

In one or more embodiments, data for preprocessing is extracted from the database 114 and/or an external database. The data includes a dataset having text that has been reviewed and labeled for hatefulness. For example, a dataset may include one or more articles and/or other media content (or reviewed text) where each article has been independently reviewed and labeled as having a determined degree of hatefulness based on racism, misogyny, homophobia, and/or other forms of discrimination. A portion of or all of the data may be retrieved from a third party fake news corpus (e.g., a publicly available news dataset of articles that have been reviewed and labeled as hateful). In one or more embodiments, the data used for the bias detection method may be used to supplement data from a fake news corpus. Although the data used for bias detection may only include labels for objectivity and subjectivity, in one or more embodiments, the data is from reliable data providers, and therefore, the data may be labeled as not hateful for the purposes of the hate speech detection method.

In one or more embodiments, preprocessing for the hate speech detection method is similar to the preprocessing for the claim detection method. For example, the preprocessing for the hate speech detection method includes the same functions as the claim detection method, however, the functions may call indicators of or labels of hatefulness (e.g., racism, misogyny, homophobia, and/or other forms of discrimination) rather than reliability and/or fakeness. In one or more embodiments, the labels for hatefulness are also removed for training purposes.

In one or more embodiments, preprocessed data in the database is consulted or extracted to train the hate speech detection model. The preprocessed data may include any number of articles or other media content, for example, a single article or thousands of articles, videos, etc. The preprocessed data may be used as training data where the preprocessed data is fed into a main training loop. During the training loop, padding may be carried out on the training loop to make it uniform prior to feeding the padded data through a custom loader that creates batches on which training can be carried out.

In one or more embodiments, training for the hate speech detection model is similar to training for the bias detection model. For example, the training for hate speech detection model uses a linear attention class, a first CNN, a second CNN, and a main model class CNN as described in the training for the bias detection model with suitable changes to accommodate hateful labels. In one or more embodiments, the hate speech detection model uses objectivity and/or polarity in addition to other suitable features for improved results (e.g., a more robust or accurate model).

Accordingly, the training for the hate speech detection model may determine a hate score (e.g., a probability score). In one or more embodiments, a lower score indicates more hate while a higher score indicates less hate. In one or more embodiments, the determined hate score is compared to the hate score of a ground truth. The ground truth in this context may refer to hate scores determined based on previous hate speech detection models and databases comprising articles or other content that have been reviewed and labeled for indicators of hatefulness. The main model class CNN may use cross entropy loss and the bias detection model may be saved after a set number of epochs to improve inference performance. Although “lower score” and “higher score” are used to indicate “more hate” and “less hate” respectively, one of ordinary skill in the art would appreciate that any suitable scoring system may be used to indicate “more hate” or “less hate”. For example, in one or more embodiments, a lower score may indicate less hate while a higher score indicates more hate.

In one or more embodiments, the hate speech detection model performs inferencing in the same manner described as the bias detection model. Therefore, the impact of every sentence may be measured and, for example, the top fifth of total sentences that had the largest impact on (e.g., largest change in) the hate score may be identified by the server as hateful sentences. The hateful sentences may be provided (e.g., displayed) to a user viewing the portion of the data feed including the article or other piece of content (e.g., media broadcast) that inferencing is performed on. In one or more embodiments, the sentences having a hate score above a threshold value (e.g., a fixed objective threshold hate score, a hate score in a top percentile (such as the top 20%, the top 15%, or the top 10%) of all of the hate scores of the sentences in the content's text, or a hate score higher than the next highest hate score by a threshold amount) may be provided (e.g., displayed) to the user.

In one or more embodiments, the bias detection method, the claim detection method, and the hate speech detection method may be concurrently (e.g., simultaneously) applied and the resulting sentences may be concurrently (e.g., simultaneously) provided to a user.

In one or more embodiments, neural network algorithms directed toward content summarization may be applied by the server 106 as directed by the software module 109. For example, the software module 109, in one or more embodiments, may manage a request from a user 110 or data providers 112 to summarize an article or other content. In response, the processor 118 of the server may execute instructions in the memory 120 corresponding to a summarizer to summarize the article.

In one or more embodiments, the summarizer is trained to capture journalistic style highlights of the content 116 (e.g., the article(s) 130, the video(s) 122, the text 124, the image(s) 126, and/or other content 128). In the case in which the content 116 includes one or more articles 130, the algorithm learns to identify important sentences in varying contexts by paying attention to not only the global interpretation of a sentence but how the sentence interacts with other sentences within the article 130.

In one or more embodiments, the summarizer method includes applying a summarizer model to a selected portion of a data feed 104 (e.g., an article, a media broadcast, and/or a 3rd party platform's media content). The summarizer model may be trained based on preprocessing data and may be updated or retrained periodically.

In one or more embodiments, data for preprocessing is extracted from the database 114 and/or an external database. The data may include a dataset specifically for summarization tasks (e.g., any suitable news datasets built for summarization or gisting purposes that can be used for training). For example, the dataset may include an article and a summary (e.g., a collection of highlights) as the ground truth.

In one or more embodiments, preprocessing includes loading a dataset including one or more news articles and/or other media content. Each article of the one or more news articles may be split into a story, highlights, and/or a title (or headline). Preprocessing further includes using an encoder to provide vector representations of each article. The encoder may be based on any suitable language representation model to find vector representations/embeddings of the words in articles of the dataset, for example, a language representation model is described in an article by Jacob Devlin, Ming-Wei Chang, Kenton Lee, Kristina Toutanova titled “BERT: Pre-training of Deep Bidirectional Transformers for Language Understanding” (2018) (last revised May 24, 2019) available at https://arxiv.org/pdf/1810.04805.pdf. In one or more embodiments. the encoder may stack the source text, the vector representation of the text, and the label vectors. The stack formed from preprocessed data may be used to create a dictionary for the various features of each article (or reviewed text), and the dictionary may be appended to the preprocessed data in a database (e.g., database 114 and/or an external database) for future access. In this manner, the dictionary may be quickly consulted without having to preprocess the dataset again.

In one or more embodiments, training capitalizes on transfer learning between a long short term memory (“LSTM”) network and a transformer network. The transformer network starts learning by using the parameters from the LSTM network and then continues on in the normal fashion. By using both the LSTM network and the transformer network, better results are provided than using only one network.

In one or more embodiments, the LSTM training method includes loading the preprocessed data (e.g., files stored by a preprocessor in a previous phase). The LSTM training method includes creating a custom data loader for loading the actual records and making batches out of them to supply to a main training loop. To do this the LSTM training method includes uniformly padding the input to be of constant size. Both the vector representations of text and labels may be padded.

In one or more embodiments, the main LSTM network is defined in the LSTM class. The final linear layer of the LSTM network may convert the data to linear dimensions and a softmax may be carried out. The logits may then be reshaped again and returned. For the loss paddings may be disregarded and classification labels may be compared using cross entropy loss which may be tuned for giving a much higher penalty when the model predicts the wrong output. The LSTM training method further includes calculating the accuracy according to different relevant factors using any suitable metric known to one of ordinary skill in the art. The training loop uses this network model and updates parameters accordingly. The training loop may then save the trained parameters so that they can be used by the transformer network.

In one or more embodiments, the transformer training method includes using two LSTM layers at the start of the network. The two LSTM layers may be the same layers as in the LSTM network and may be used to load the pre-trained parameters from the LSTM network. The layers may then pass on the logits to the main transformer network.

In one or more embodiments, the transformer training method includes a multiheaded attention class, a norm class, and a feedforward layer class. The multiheaded attention class is configured to calculate the multi headed attention values. Multiheaded attention allows the attention module to focus on different positions as well as gives the attention layer multiple “representation subspaces”. The norm class is configured to calculate the mathematically stable norm values used in transformer calculations. The feedforward layer class is configured to define feedforward layers for the transformer to use in the network.

In one or more embodiments, the transformer training method includes a transformer class. The transformer class is configured to use the multiheaded attention class, the norm class, and the feedforward layer class to create a full transformer model. The transformer class goes through a series of norm operations into the multi headed attention layer and then into the feedforward layers.

In one or more embodiments, the transformer training method includes a transformer class. The transformer class is the main class which is configured to encapsulates all of the above modules into a functional pipeline. The transformer class includes a custom initialization function to load pre-trained parameters from the LSTM network if transfer learning is set to True. The transformer class initializes the transformer according to the arguments (e.g., number of transformers and number of attention heads). In one or more embodiments, the arguments can be customized as the dataset evolves and new hyperparameters are needed.

In one or more embodiments, the loss for the transformer training method is calculated in a manner similar to the LSTM training method. The transformer training method computers actual predictions from logits to evaluate the loss. In one or more embodiments, cross entropy is tuned or retuned to a different value to provide the required level of penalty. The training loop incorporates the above network and evaluates the loss and updates the parameters. The parameters are then saved for inferencing.

In one or more embodiments, the summarizer model loads the pretrained weights saved from training. The summarizer model then takes the test content's text (e.g., articles, videos, etc.), passes it through preprocessing (e.g., without labels), creates a batch and passes the encoded content into the network set to eval mode. Using the softmax logits the summarizer model computes a summary score for each sentence. This summary score refers to the probability of the sentence being in the summary.

In one or more embodiments, the sentences are sorted according to their summary score in the decreasing order and the top sentences are chosen for the summary according to various requirements of the current summarization task (e.g., minimum number of sentences, max number of sentences, length range of sentences etc.). The number of top sentences chosen may be adjusted from one sentence to the max number of sentences in an article as desired.

The top sentences may be provided (e.g., displayed) to a user viewing the portion of the data feed including the article and/or other content (e.g., a media broadcast) that inferencing is performed on. In one or more embodiments, the sentences having a summary score above a threshold value (e.g., a fixed objective threshold summary score, a summary score in a top percentile (such as the top 20%, the top 15%, or the top 10%) of all of the summary scores of the sentences in the article, or a summary score higher than the next highest summary score by a threshold amount) may be provided (e.g., displayed) to the user.

Because the summarizer model breaks articles into words and because news articles and other content may be written in various styles, the summarizer model sometimes loses the punctuation and syntactic information when outputting a rough summary. In one or more embodiments, this issue is addressed by a separate post processing pipeline which uses commands from a software library to clean and properly punctuate the text. Accordingly, the output from the summarizer model is passed through the post processing pipeline and a neat summary is generated. In one or more embodiments, the post processing pipeline can be used for several text cleaning tasks to provide neat text to users beyond just the output of the summarizer model.

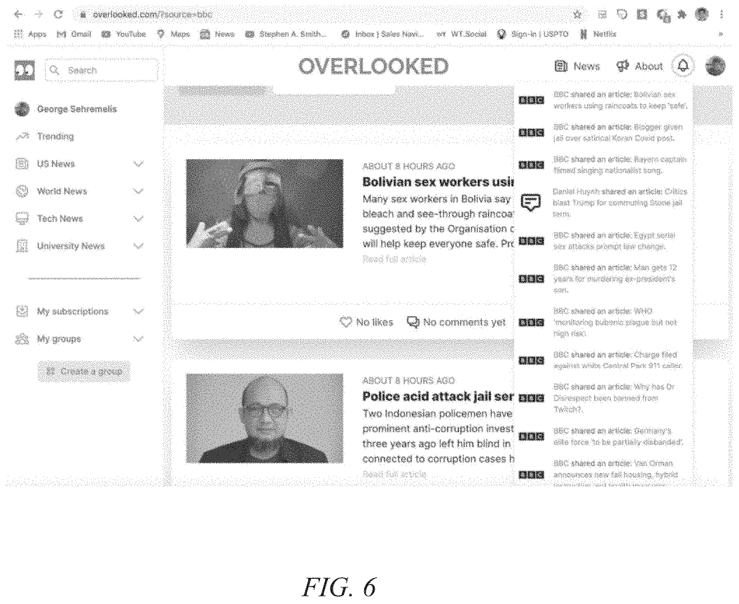

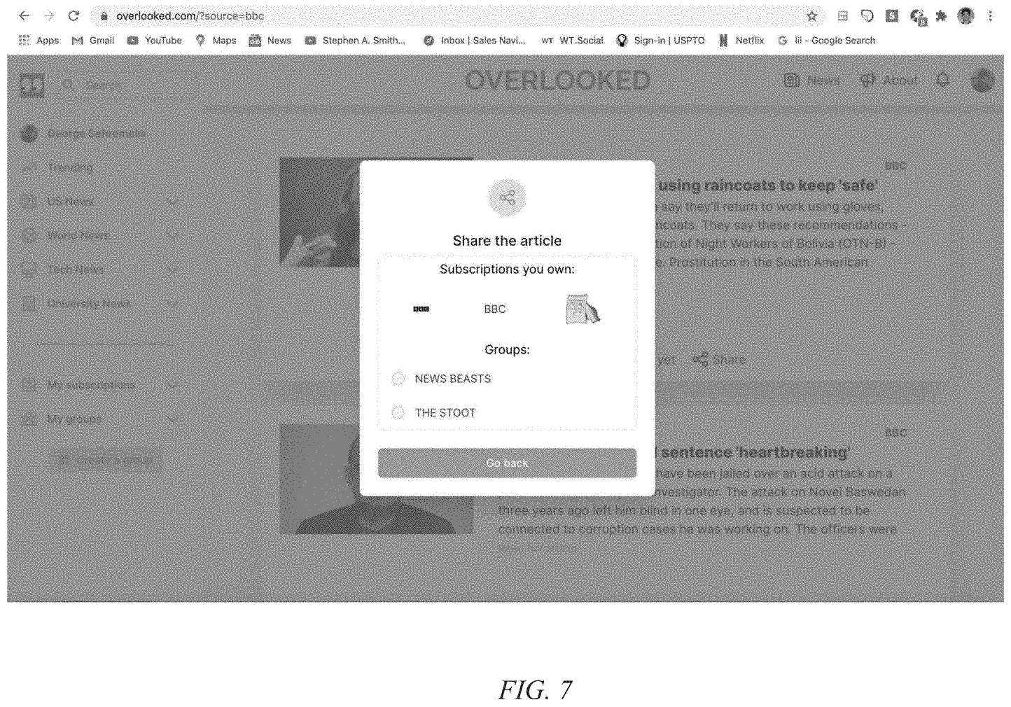

FIG. 6 is a screenshot of a platform displayed on the electronic device 108 of the user 110 by the software module 109. The platform includes a data feed 104 showing various news articles and other content (e.g., media broadcasts, video, etc.) from data providers 112. The articles may be posted by the data providers 112 or otherwise obtained from the data providers (e.g., pulled from the data providers 112). In one or more embodiments, the software module 109 is configured to enable a user 110 to “subscribe” to one or more particular data providers 112. For example, in one or more embodiments, the software module 109 may be configured to display an icon on the data feed 104 of the electronic device 108 of the user 110, which, when selected by the user, subscribes the user to the associated data provider 112, as shown in FIG. 7. FIG. 7 also depicts the option to share an article on other platforms according to one embodiment of the present disclosure. The data provider 112 may be a content provider such as a news organization, a vetted user or platform, or a business among other things, such as the BBC, PBS, CNN, or AP News. In one or more embodiments, when a user 110 is subscribed to a data provider 112, the data provider 112 is able to send push notifications to the user 110 (i.e., the data provider 112 is able to send push notifications to subscribed users 110). These push notifications may include notifications of content recently posted by the data provider 112 or pulled from the data provider 112. In this manner, the software module 109 enables the data providers 112 to send targeted notifications to those users 110 who are subscribed to the data provider 112 without compromising the system's safeguards against disinformation.

In one or more embodiments, the software module 109 is configured to display, on the data feed 104 of the electronic device 108 of the user 110, a page that is specific to the data provider 112 (e.g., a business page or journalist profile). The specific page for the data provider 112 may display press releases, content, and/or sponsored articles containing content related to the data provider 112. In one or more embodiments, the data provider 112 (e.g., a business or journalist) may link to its website or other information pertinent to its business on its specific page (e.g., email, cell phone, etc.). In one or more embodiments, the specific page for the data provider 112 may be limited to display only articles or other text-based content (e.g., the specific webpage for the data provider 112 may or may not include purely visual content, such as images, graphics, or photographs). In one or more embodiments, the specific page of the data provider 112 may include articles containing text and audiovisual content (e.g., image(s) and/or video(s)). Additionally, in one or more embodiments, content (e.g., sponsored articles or press releases, among other data) published on the specific page for the data provider 112 may be sent, by the data provider 112, to subscribers, news organizations, persons of interest, or specific journalists via an email newsletter or email marketing services for content providers, URL or hyperlink, outside social media profiles, or a platform profile (if a journalist has created one), among other ways, to generate press or other reputational gain or insight for the data provider 112. A content provider (e.g., creator, business, publisher) may be able to import contact information (e.g., a list of subscribers) into the email newsletter service and have a dashboard to track growth. A creator may connect to payment processors (e.g., Stripe) to access revenue through the platform. Additional data pertinent to media relations groups, journalists, topic experts, university professionals or others may be sent via “push” notifications. Furthermore, in one or more embodiments, the content (e.g., “sponsored” articles, contact information, press releases, etc.) posted on the specific page for the data provider 112 may be sent, by the data provider 112 or other users, to other social platforms, such as Facebook, Twitter, Google, Tiktok, or LinkedIn. The platform may provide search engine optimization (SEO) services for businesses and publishers who want to backlink their content, webpages, etc. that may link data, metadata, algorithms, or functions to improve SEO. The content may be posted to the other social platforms in real time or may be scheduled for publication at a future time on the same day or at a future date and time. Furthermore, the software module 109 may be configured to enable the data provider 112 (e.g., the business) to send push notifications regarding the content (e.g., articles or press releases) published on the data provider's specific page to its subscribers. In this manner, the page that is specific to the data provider 112 makes it easy for customers or potential customers to learn about the data provider's 112 business and the goods and/or services offered by the data provider 112. Furthermore, in one or more embodiments, the specific page for the data provider 112 (e.g., the business page) may include RSS (i.e., Really Simple Syndication or RDF Site Summary) to enable the specific page to be fetched by an RSS feed reader and, for example, displayed with information from other sites in a news aggregator (or web scraper). In one or more embodiments, the specific page for the data provider 112 may also enable the data provider 112 to make the page private or public to different lists of subscribers or sets of users who are granted administrative access.

In one or more embodiments, the software module 109 may be configured to display an advertisement portal in which an advertisement buyer (e.g., a user or business) can create and promote a sponsored article, hyperlink, content, and/or a press release to other users on the platform. In one or more embodiments, advertisement buyers may be able to create and purchase an ad and target it to the general platform data feed 104 among other feeds, to users who subscribe to specific data providers (e.g., newspapers, journalists, publishers, etc.), email newsletters, and/or to users matching specified demographic, geographic, psychographic, and/or behavioral segmentations. Publishers may have the ability to decline certain advertisements via a DAO among other abilities in their own dashboard where they can track advertising revenue, subscription revenue, and user reach and/or engagement among other things. In one or more embodiments, the ads may direct people to an announcement on the platform (e.g., an announcement on the data feed 104 or the page of the data provider 112), a web URL, or a social media handle, among other things.

In one or more embodiments, the software module 109 is configured to enable data (e.g., an article, a “sponsored” article, a media broadcast, or a press release) displayed on the data feed 104 (e.g., a user's data feed or a data provider's specific page) to be sent, by the user 110, the data provider 112 (e.g., a publisher), or a business, to other platforms, such as Facebook, Twitter, or LinkedIn. The content may be posted to the other platforms in real time or may be scheduled for publication at a future time on the same day or at a future date and time. This may coincide with email newsletter marketing and push notifications to the website and mobile application.

Additionally, in one or more embodiments, the software module 109 is configured to generate a URL among other metadata for tracking and displaying the number of times specific content and user data (e.g., an article, contact information, a press release, trends, etc.) was posted on its system and to other social platforms, and displaying the profiles (e.g., names) of the businesses or individuals who received, viewed, or shared the content. In this manner, businesses may enter the URL into an electronic device 108 and determine how many times an article among other content was received, viewed, or shared and which key people of interest were involved within the content, received, viewed, or shared it. In one or more embodiments, the software module 109 is configured to generate and display an analytics dashboard to display the effectiveness and metrics of a data provider's URLs, subscriber growth, and of purchased advertisements, among other things.

In one or more embodiments, the software module 109 is configured to generate audio, utilizing text to speech (or speech to text) artificial intelligence, based on the content (e.g., news articles, videos, press releases, etc.) of the data provider 112 displayed on the user's data feed 104 (e.g., the business page of the data provider, or the data feed displaying data from multiple data providers). For instance, in one or more embodiments, the software module 109 may be configured to display an icon on the data feed 104 of the electronic device 108 of the user 110, which, when selected by the user, generates audio from a speaker of the user's electronic device 108 based on the text contained in the associated article or piece of content. The audio may contain several different “voices” and algorithms may be used to shuffle the voices or to create “playlists” of news articles and/or other media related content. Additionally, in one or more embodiments, the software module 109 is configured to display audiovisual pages that indicate to the user 110 how long they have been listening, the content's ‘cover,’ and/or how long it will take for them to complete listening to an article (i.e., the time that has elapsed and/or the time remaining to completion). Additionally, in one or more embodiments, the software module 109 may be configured to generate text from speech (e.g., video, podcast, broadcast, radio) and to re-display the text as content on the platform. In one or more embodiments, a data provider may create and record audio (e.g., a podcast or music) through a dashboard and monetized via newsletter distribution, NFTs, notification, etc. through the platform.

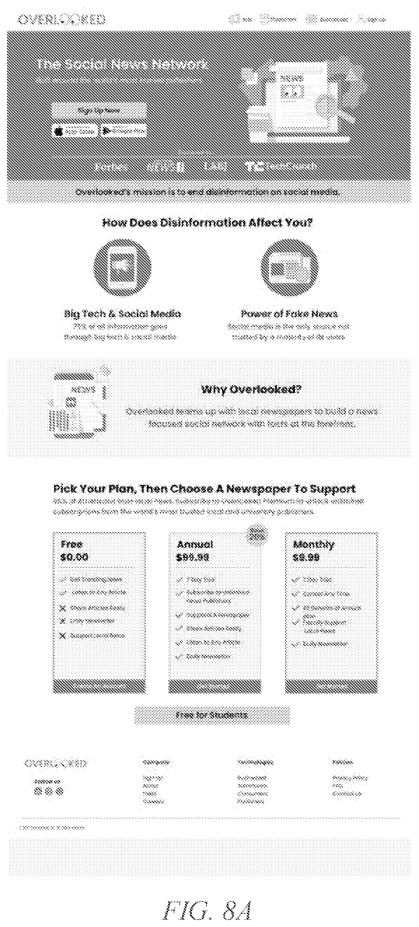

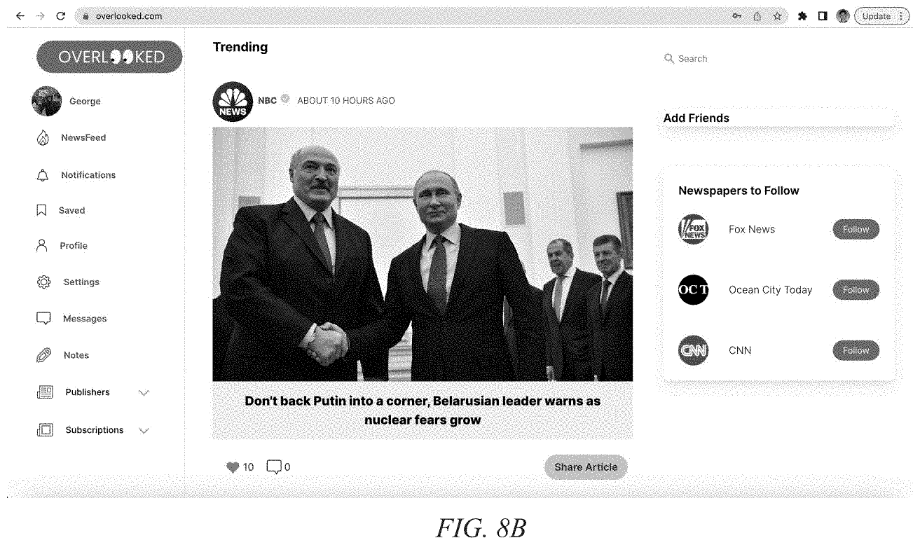

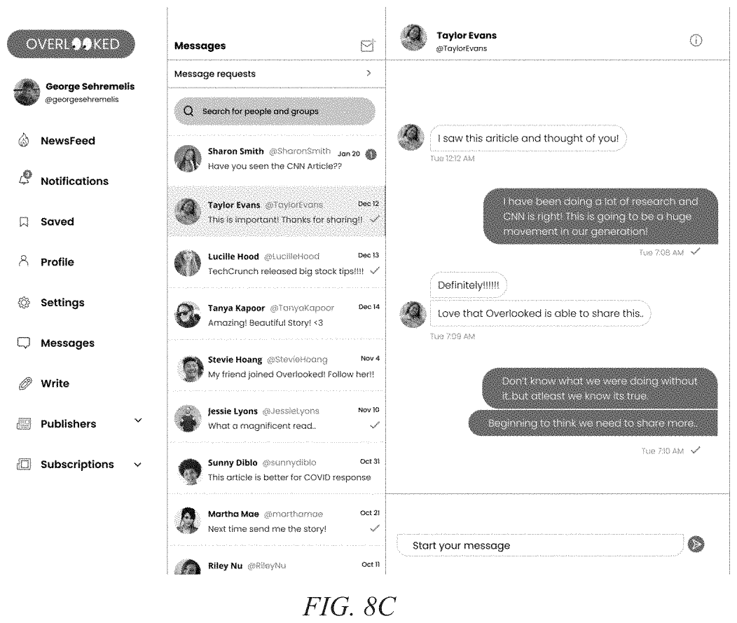

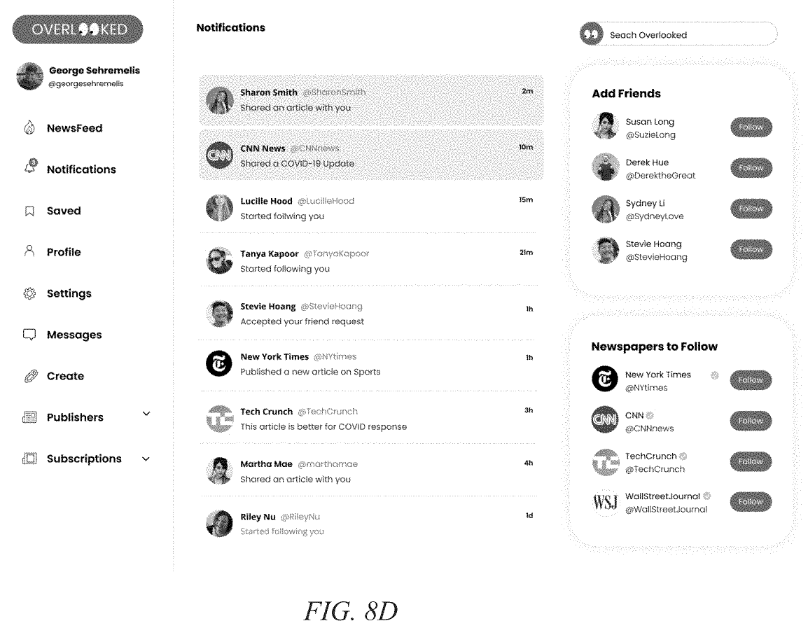

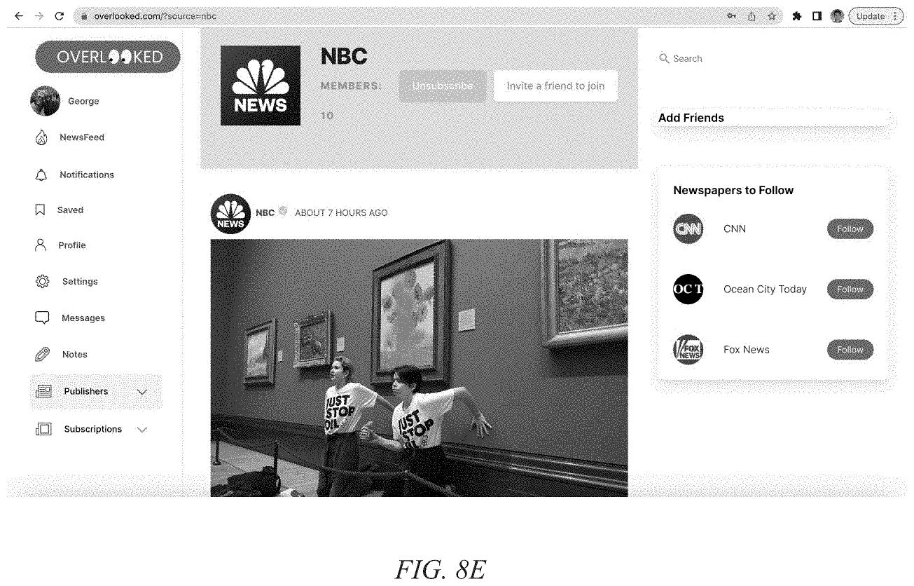

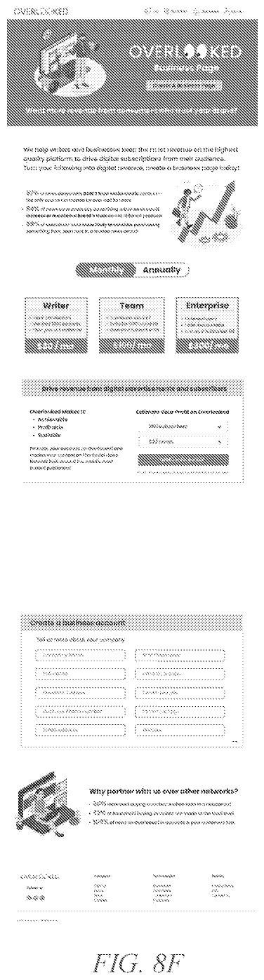

FIGS. 8A-8F depict screenshots of a website and a mobile application incorporating the algorithms and other functionality of the present disclosure. FIG. 8A depicts a home page of the social news network according to one embodiment of the present disclosure. FIG. 8B depicts a trending news feed and search functionality of the social news network, including a button (“Share Article”) to enable sharing of the news articles, on the newsfeed of the social news network according to one embodiment of the present disclosure. FIG. 8C depicts a messages page enabling communications between uses of the social news network. FIG. 8D depicts a notifications page of user profile of a user of the social news network according to one embodiment of the present disclosure. FIG. 8E depicts a publishers page of user profile of a user of the social news network according to one embodiment of the present disclosure. FIG. 8F depicts a business page and a business advertisements portal of the social news network according to one embodiment of the present disclosure.

In one or more embodiments, the algorithms, features, and/or methodologies described herein may be utilized by a content publisher (e.g., a newspaper) to generate digital recurring revenue (e.g., increased digital subscriptions and advertisements). In one or more embodiments, the content provider may be charged by the platform to get content vetted on the system's content moderation process. In one or more embodiments, the algorithms, features, and/or methodologies described herein may be utilized by a business or a creator to monetize their content and/or audience, among other things.

In one or more embodiments, the instructions stored in the memory device, when executed by the processor, are configured to cause the processor to display, on the display of the electronic device, a social news network having a newsfeed that displays a variety of news items or other content (e.g., articles, audio files, video files, and/or pictures) from publishers or creators, and each item of content displayed on the newsfeed is connected via a smart contract and stored in or attached to a blockchain tied to a platform coin or token governed by a platform decentralized autonomous organization (DAO) among a greater ecosystem of sub-chains, altcoins, and sub-DAOs. Storing the content on the blockchain enables verification of the authenticity of the content and thereby prevents or at least mitigates against the dissemination of misinformation. In one or more embodiments, content may be stored onto a proof a stake blockchain, a proof of work blockchain, or a blockchain utilizing a combination of proof of stake and proof of work, and the validators and challengers may be the data providers (e.g., publishers, creators, businesses, etc). Proof-of-work (i.e., “mining”) is done by miners, who compete to create new blocks full of processed transactions, and the winner shares the new block with the rest of the network and earns some newly minted cryptocurrency. Proof-of-stake is a consensus mechanism for processing transactions and creating new blocks in a blockchain (i.e., proof-of-stake is a method for validating entries into a distributed database and keeping the database secure).

The challenger/validation process may result in a reward of the platform coin. Pre-vetted content providers (e.g., journalists) may vet content daily or over a certain period of time to earn a reward of platform coin, as long as the vetted content is within a margin of error of a consensus regarding the accuracy of the content amongst the consensus of pre-vetted challengers/validators. This creates a forcing function to limit the amount of user error and incentivizes validators to fact check and validate based on the ground truth. There may also be proof of work aspects on the proof of stake chain and vice versa. The contents of the newsfeed may be stored in any suitable blockchain (e.g., each item of content may be stored in a unique blockchain associated with the social news network, or a common open-source blockchain with smart contract functionality, such as Ethereum). Additionally, as described in more detail below, the content displayed on the newsfeed may be democratically moderated or governed by a decentralized autonomous organization (DAO) (i.e., a decentralized governance) formed among the publishers and/or the creators and/or the company and/or its users. In this manner, the social news network functions as a decentralized application (DApp) on the blockchain. The use of the blockchain for the social news network, including the use of the DAO as a democratized content moderation scheme, creates public access to information from the platform to users via a digital ID, virtual private network (e.g., VPN), or wallet among other methods across authoritarian and other “blacklisted” government regimes to promote the freedom of information around the world.

In one or more embodiments, only those items of content that are approved by members of the DAO may be posted to the newsfeed and/or other pages of the social news network (i.e., the members of the DAO govern and enforce the rules for posting items of content to the newsfeed of the social news network). Screened or vetted content moderators may be rewarded with platform coin when their validation decisions are within the margin of error for accuracy for content, which may use algorithms that identify consensus to verify ground truth. These may be, for example, sentiment analysis algorithms that screen text for similar topics, titles, networks, journalists, etc, or other consensus algorithms to help with the content moderation process for each block of a proof of stake or proof of work blockchain. For example, in one or more embodiments, decisions to post an item of content (e.g., an article, a video, a picture, or an audio file) to the newsfeed and/or other pages of the social news network may be made via a proposal that the members of the DAO vote/verify on during a specified period to verify a block of content on the chain. In one or more embodiments, content may be posted on the newsfeed and/or other pages of the social news network only by members of the DAO. In one or more embodiments, members of the DAO may be permitted to post content to the newsfeed without pre-approval from the other members of the DAO. In one or more embodiments, content moderation may be decentralized by members of the platform DAO among sub-DAO's consisting of publishers and/or creators and/or the company and/or its users.

In one or more embodiments, membership in the DAO may be governed by ownership of one or more coins or tokens or a fractionalized portion thereof (referred to herein as a “platform coin” or “platform token”), and the rules that govern operation of the DAO are implemented by executing a smart contract stored on the blockchain. As used herein, the term “coin” refers to use of a cryptocurrency associated with a blockchain associated with the social news network, and the term “token” refers to the use of a cryptocurrency associated with a third-party blockchain which may or may not be linked to the main platform chain. Additionally, in one or more embodiments, the governance rules of the DAO may be modified by a vote of the members of the DAO (e.g., a majority vote, a super majority vote, or a unanimous vote of the DAO membership may be required to modify the governance rules of the DAO). In one or more embodiments, there may be a fixed (capped) supply of coins/tokens (e.g., 21 million coins), or the number of coins/tokens may be variable (e.g., more coins/tokens may issue). Additionally, in one or more embodiments, the coins/tokens may be distributed non-uniformly (e.g., the number of coins/tokens distributed via staking or mining rewards may decrease over time; for example, the number of coins/tokens distributed may halve after a set period of time or other threshold). The coins may be fractionalized, for example into a similar manner as satoshis (100 millionth of a Bitcoin), and the fractionalization may be outlined in a publicly available (i.e., open source) document (e.g., in a “whitepaper”), which may occur in conjunction with certain open source code on the social news network. In one or more embodiments, the instructions stored in the memory device, when executed by the processor, may cause the processor to distribute a set number of coins or tokens (for membership in the DAO) to each digital wallet of the publishers or creators. In one or more embodiments, challengers and validators may stake more currency/cryptocurrency to increase their chances of being able to validate the next block of content and be rewarded with platform coin for moderating content. In one or more embodiments, the system may be configured to distribute a set number of coins or tokens to each digital wallet (e.g., a set number of coins or tokens are distributed to subscribers), and the system may offer coins or tokens via an initial coin offering (ICO). In this manner, funding may be raised via coins or tokens rather than equity (stock) ownership. Thus, the system of the present disclosure provides a digital coin ecosystem for media or other content creators. In one or more embodiments, the governance rules of the DAO, including the procedure for content moderation and approval and the definition of a trusted publisher or content creator (among other things), are publicly available (i.e., open source) in a “whitepaper,” which provides transparency, accountability, and public confidence in the veracity of the information posted on the newsfeed.

Additionally, in one or more embodiments, the instructions stored in the memory device, when executed by the processor, restrict the electronic device from displaying the content from the publishers or the creators to the newsfeed without prior authorization. For instance, in one or more embodiments, the instructions stored in the memory device, when executed by the processor, cause the processor to display, on the display of the electronic device, content only from a white list of creators and/or publishers (e.g., a white list of news organizations, such as organizations having reliable journalism credentials and/or reputable national or international news organizations).

In one or more embodiments, one or more members of the DAO (i.e., a publisher or content creator) may create and offer alternative coins on the blockchain or sub-chains to enable the publishers and/or the content creators to self-moderate content. For instance, in one or more embodiments, a member of the DAO may issue coins or alternative coins to its content creators or other employees or contractors (e.g., editors, reporters, etc.), and the holders of those alternative coins may vote (in proportion to their coin/DAO ownership) on whether to approve or reject content from the publisher from being posted on the newsfeed.

In one or more embodiments, the system may require businesses, publishers, and content creators to post a bond or make a security deposit (e.g., fiat money, cryptocurrency, and/or assets) when submitting content to be displayed on the social news network. The bond or security deposit is a financial deterrent against disseminating disinformation on the social news network (i.e., monetizing the truth). That is, the purpose of requiring a bond or security deposit may be to align a financial incentive and possible risk scenarios with limiting disinformation on the social news network. The bond or security deposit will be forfeited if the accuracy of the content is successfully challenged. The bond or security deposit will be returned to the publisher or content creator if the accuracy or validity of the content is not challenged or is challenged unsuccessfully. For instance, in one or more embodiments, every node of the blockchain network that provides content to the social news network may need to hold assets in their nodes, similar to Ethereum staking, as a security deposit against disseminating disinformation. Challenger/validator nodes of the blockchain, who may get paid to moderate the content of the social news network (e.g., by earning part of the revenue generated by the publishers or content creators), may question the accuracy of any content posted by one of the nodes, challengers, or validators (e.g., businesses, publishers, and/or content creators). A validator node is a special type of full node that participates in “consensus.” By participating in consensus, validator nodes become responsible for verifying, voting on, and maintaining a record of transactions. A validator's purpose may be to find consensus amongst challenges against or for the accuracy of the content that is to be put on chain before or after it meets certain criteria per DAO or self-executing code (e.g., smart contract). In one or more embodiments, these challengers/validators may have to post a bond or security deposit (e.g., fiat money, cryptocurrency, and/or assets) before challenging the validity or accuracy of content posted to the social news network. Once a challenge is initiated, the validators will vote on whether the challenged content contains disinformation. If the result of the vote determines that the content contains disinformation, the publisher or content creator of that content will forfeit its bond or security deposition. If the result of the vote does not determine that the content contains disinformation, the challenger/validator that challenged that content will forfeit its bond or security deposition. This opportunity to challenge content may be available only for a certain time period. Additionally, in one or more embodiments, the challengers/validators may be previously vetted by the platform, which is configured to prevent bots from moderating content, among other things.

Additionally, in one or more embodiments, the instructions stored in the memory device, when executed by the processor, cause the processor to display a mining portal on the social news network. In one or more embodiments, the mining portal may be displayed on a profile page of (or associated with) the publisher or the content creator. The mining portal enables users (such as the publishers and verified creators) to mine the alternative coin offered by the publisher or the content creator, and/or to mine the platform coin, such as with a mining ASIC for a proof of work blockchain (i.e., hardware) that can utilize its computing power (e.g., power (W), HashRate (Th/s, Gh/s, etc.), noise (db), algorithms) to convert energy sources and solve equations to moderate (e.g., fact check) content on the blockchain through a decentralized system that cannot be hostilely taken over by a bad actor, government, company, etc. Accurate content moderation (e.g., fact checking) may be rewarded via distribution of a coin through its verification on the blockchain ledger. Total hash rate on the system may increase or decrease as more ASICs provide computing verification of content on the network. Network difficulty may convey how difficult it is for a mining ASIC to mine a new ‘verified block’ of content on a blockchain having previously proven its accuracy in a decentralized manner on the network. In this manner, users and miners may ethically support the publishers in the moderation of content offered by the publisher or creator. Accordingly, the system may better align the digital media and information ecosystem's incentive structure through giving mining rewards to miners participating in a democratic content moderation process that is decentralized via DAO and may include vetted publishers along with miners and users who may convert energy sources into to computing power to hash facts or ground truth (e.g., fact check content on the social news network) on a ledger. They may represent nodes on a blockchain that is attached to the social news network website and mobile application via a dapplication. The system may use algorithms to assist in this process, and the system may have a backup to ensure that there is no hostile takeover from a single entity or bad actor.

In one or more embodiments, the process of mining coins through the mining portal and proof of work blockchain may be powered by a renewable or sustainable power source, such as hydro energy harvested from a river or an ocean, thermal energy harvested from a volcano, ultraviolet energy harvested from the sun, energy generated from a nuclear reactor, quantum energy, energy generated from a satellite in outer space, among other sustainable energy sources. In one or more embodiments, the process of mining coins through the mining portal may use energy created from recycling print newspapers. In one or more embodiments, this methodology may be used to bring publisher's “overhead costs” (e.g., electricity, rent, etc.) towards 0 or make it profitable (or more profitable). In one or more embodiments, the system of the present disclosure may include a mining ASIC (i.e., an integrated circuit purpose built to perform mining of cryptocurrency). In one or more embodiments, any other suitable type of mining may be utilized, such as mobile GPU mining.

In one or more embodiments, the instructions stored in the memory device, when executed by the processor, cause the processor to analyze quantum cryptocurrency connected to fundamental theories of physics at the scale of atoms and subatomic particles in the fields of chemistry, quantum field theory, quantum technology, and quantum information science. That is, in one or more embodiments, the system is configured to utilize quantum cryptography to encrypt content and transmit the encrypted content (e.g., articles, videos, images, and/or audio files) such that it cannot be hacked, which enables verification of the veracity of the content displayed on the newsfeed and/or the smart contracts (such as NFTs) offered on the digital marketplace to thereby prevent (or at least mitigate) the dissemination of disinformation. Other cybersecurity features and methodologies may be implemented to guarantee that the network cannot be hacked or be subject to a ‘hostile takeover,” including generating and distributing emergency keys to trusted sources that may be utilized to ‘unlock’ and safeguard the network. This may include threat protection for malware, security, phishing, encrypted technology, to allow users to bypass virtual location and region lock and content restriction

Furthermore, in one or more embodiments, the instructions stored in the memory device, when executed by the processor, cause the processor to display a coin ticker on the profile page associated with the publisher or the content creator. The coin ticker displays, in real-time, the value of the coin or alternative coin offered by the publisher or content creator associated with the profile page. Additionally, in one or more embodiments, users may be able to purchase, sell, and/or exchange the coin of the listed publisher and store the coin or token of the listed publisher in a portfolio on their digital or hardware wallets. Furthermore, in one or more embodiments, the system may enable users to stake the platform or alternative coins (i.e., earning interest by holding the coins in their digital wallet for a fixed period of time).

In one or more embodiments, the instructions stored in the memory device, when executed by the processor, are configured to cause the processor to display, on the display of the electronic device, a digital marketplace including a series of smart contracts, such as non-fungible tokens (NFTs), available for purchase. The NFTs are stored in digital wallets associated with one or more publishers (e.g., one or more news organizations) and/or creators. The NFTs may include one or more images (e.g., one or more newspaper covers), content, articles, videos, and/or audio files among other content on the social news network. For example, users/creators may create or write a piece of content such as an article and publish it as an NFT for sale on the platform, the platform blockchain, or an unaffiliated blockchain, and users may be able to validate such content (e.g., articles) via governance in a DAO prior to the addition of such content (e.g., articles) to the NFT marketplace or blockchain. In this manner, users may be able to crowdfund for ideas and fundraise via smart contracts and monetize news content including articles sold as NFTs on the digital marketplace. The NFTs may be any suitable type of file type, such as JPG, PDF, PNG, GIF, SVG, MP4, WEBM, MP3, WAV, OGG, GLB, GLTF, or combinations thereof. In this manner, the digital NFT marketplace enables the discovery, collection, selling, buying, and trading of NFTs. For example, the digital NFT marketplace of the present disclosure enables individuals or entities to own and trade (or sell) historical moments reported by newspapers or other trusted media organizations. In one or more embodiments, one or more of the NFTs offered on the digital marketplace may include a collection or compilation of digital content items, such as the most popular or noteworthy news articles, videos, pictures, or audio clips in a particular time period. In one or more embodiments, the smart contracts (such as NFTs) can be auctioned (e.g., via a timed auction, such as a descending-bid or “Dutch auction” in which the price of an NFT starts at a ceiling (maximum) price and drops by a fixed amount periodically, or an ascending-bid or “English auction” in which the incrementally increasing bids are solicited until a winning bid is reached). Furthermore, in one or more embodiments, revenue generated from the sale of the smart contract (such as NFTs) may be shared between the publisher/creator of the content and other users of the platform.

Additionally, in one or more embodiments, the instructions stored in the memory device, when executed by the processor, restrict the electronic device from displaying the smart contracts, such as the NFTs, from the publishers or the content creators to the digital marketplace without prior authorization, such as approval through the governance of a decentralized autonomous organization (DAO). For instance, in one or more embodiments, the instructions stored in the memory device, when executed by the processor, cause the processor to display, on the display of the electronic device, smart contracts (such as NFTs) only from a white list of creators and/or publishers (e.g., a white list of news organizations, such as organizations having reliable journalism credentials and/or reputable national or international news organizations). In one or more embodiments, the smart contracts (such as NFTs) are connected to the platform with and stored in digital wallets owned or controlled by the creators and/or the publishers and the digital wallets are electronically connected to the digital marketplace.

In one or more embodiments, the instructions stored in the memory device, when executed by the processor, cause the processor to display a minting portal on the electronic device. The minting portal is configured to enable creators and/or publishers to mint their content (e.g., images, videos, and/or audio files), possibly utilizing a blockchain standard or protocol, for approval on the blockchain to generate content for the newsfeed and/or smart contracts (such as NFTs) for sale on the digital marketplace. In one or more embodiments, the minting portal may be linked or otherwise associated with the creators' and/or the publishers' profile pages on the platform. In this manner, the creators and/or the publishers may utilize the platform (e.g., the social news platform) to mint content for the newsfeed and/or smart contracts (such as NFTs) for sale, such as newspaper covers (i.e., print digital mints), through the algorithmic generation of individual content, fractionalized content, or collections and the storage of such individual content or collections on the platform or associated blockchain, digital wallets, etc.

In one or more embodiments, only those smart contracts (such as NFTs) that are approved by members of the DAO (i.e., a decentralized governance) may be posted to the digital marketplace (i.e., the members of the DAO govern and enforce the rules for posting smart contracts, such as NFTs, to the digital marketplace). For example, in one or more embodiments, decisions to post a smart contract, such as an NFT, to the digital marketplace may be made via a proposal that the members of the DAO vote on during a specified period. In one or more embodiments, smart contracts (such as NFTs) may be posted on the digital marketplace only by members of the DAO. In one or more embodiments, members of the DAO may be permitted to post smart contracts (such as NFTs) to the digital marketplace without pre-approval from the other members of the DAO. In one or more embodiments, membership in the DAO may be governed by ownership of one or more coins or tokens, and the rules that govern operation of the DAO are implemented by executing a smart contract stored on the blockchain (e.g., the proof of stake blockchain, proof of work blockchain, or a combination thereof). Additionally, in one or more embodiments, the governance rules of the DAO may be modified by a vote of the members of the DAO (e.g., a majority vote, a super majority vote, or a unanimous vote of the DAO membership may be required to modify the governance rules of the DAO). In one or more embodiments, there may be a fixed (capped) supply of coins/tokens (e.g., 21 million coins/tokens), or the number of coins/tokens may be variable (e.g., more coins/tokens may issue). Additionally, in one or more embodiments, the coins/tokens may be distributed non-uniformly (e.g., the number of coins/tokens distributed may decrease over time; for example, the number of coins/tokens distributed via staking/mining rewards may halve after a set period of time or other threshold). In one or more embodiments, the instructions stored in the memory device, when executed by the processor, may cause the processor to distribute a set number of coins/tokens (for membership in the DAO) to each digital wallet of the publishers or creators that stakes content or currency to other assets. In one or more embodiments, the system may be configured to distribute a set number of coins or tokens to each digital wallet (e.g., a set number of coins or tokens are distributed to users, publishers, subscribers, creators, businesses, and/or teams, among other things), and the system may offer coins or tokens via an initial coin offering (ICO). In this manner, funding may be raised via coins or tokens (i.e., crowdfunding) rather than equity (stock) ownership to align the incentives of the creators/publishers and the users funding the content towards limiting disinformation versus maximizing shareholder value, which tends to increase the spread of disinformation.

In one or more embodiments, the instructions stored in the memory device, when executed by the processor, cause the processor to display the newsfeed (or news items, such as articles, images, videos, and/or audio files, from the newsfeed) and/or smart contracts (such as NFTs) in a virtual reality and/or an augmented reality (or other mixed reality technology) of a “metaverse,” “omniverse,” or “digital twins” environment. The metaverse environment may be a platform metaverse or a third party metaverse. In one or more embodiments, the platform metaverse may include two or more sub-metaverses. Accordingly, in one or more embodiments, the instructions stored in the memory device, when executed by the processor, may cause the processor to display the platform metaverse and the news items and/or the smart contracts in the platform metaverse (or one or more of the sub-metaverses), or may cause the processor to transmit the news items and/or the smart contracts to a third party metaverse. In one or more embodiments, the metaverse may include virtual newsstands, virtual buildings (e.g., digital real estate, digital leasebacks), and/or virtual print newspapers, among other content, from the publishers and/or the content creators on the social news platform. In one or more embodiments, users and data providers may have avatars, which may be featured as NFTs on profiles on the social news network. In one or more embodiments, the content in the metaverse or omniverse may be immersive such that user, publishers, or businesses on the social news network may be able to create content that can be ‘sensed’ via any human senses, such as touch, smell, sight, sound, etc. In one or more embodiments, the instructions stored in the memory device, when executed by the processor, may cause the processor to display a business page in the metaverse enabling a business to set up a virtual setting such as a classroom or learning environment, a virtual school or university, a virtual media broadcasting or production setting to create or mint content, virtual real estate, a virtual office for a company, or any other suitable application in the metaverse. In one or more embodiments, these concepts may be applied to the physical world (e.g., physical newsstands and other physical real estate).

The display of content (articles, images, videos, audio files, and/or NFTs thereof) in the metaverse may be governed by the DAO in the same or similar manner as described above (i.e., the platform metaverse is decentralized by the DAO such that only those items of content that are approved by members of the DAO, as determined by ownership of a platform coin or token, may be permitted to be displayed in the metaverse). Additionally, in one or more embodiments, information on the blockchain may be used to decentralize information in the metaverse and/or across several metaverses (or several sub-metaverses). Furthermore, in one or more embodiments, the instructions stored in the memory device, when executed by the processor, cause the processor to enable individual users, publishers, and/or creators to edit and thereby safeguard their version of the metaverse in the event the metaverse is being, or has been, taken over by an Authoritarian creator. There may be reset keys stored safely amongst the publishers on the DAO or to other trusted, vetted partners on the network. In one or more embodiments, the platform metaverse (and any sub-metaverses) may be persistent and cannot be shut off.

Additionally, in one or more embodiments, the instructions stored in the memory device, when executed by the processor, cause the processor to display an advertising portal in the metaverse and/or to virtually purchase and broadcast advertisements inside of the metaverse. In one or more embodiments, the instructions stored in the memory device, when executed by the processor, may cause the processor to display any of the other features described above in the metaverse (e.g., a digital marketplace, a digital newsstand, a mining portal, and/or a minting portal may be displayed in the metaverse).

In one or more embodiments, the system includes brain-machine interface (BMI) devices to enable users to interact with the metaverse. For example, neural signals of a user may be interpreted by the BMI device to enable the user to interact with the metaverse, including navigating (e.g., exploring) the metaverse, posting content to the metaverse (e.g., content from the user's brain), and/or conducting transactions (e.g., NFT sales and purchases) in the metaverse. Utilizing the BMI device to download or otherwise transfer the content of the user's brain to the metaverse enable the user to “live” and “afterlife” in the metaverse as guided by their own settings, which may be open source and may have defensible backup systems to protect against any takeover from bots, authoritarian takeover, among other things. Additionally, in one or more embodiments, energies from the augmented reality devices (or other mixed reality devices), the virtual reality devices, and/or the BMI hardware may be mined into cryptocurrency or platform coin.

In one or more embodiments, the instructions stored in the memory device, when executed by the processor, cause the processor to display, on the display of the electronic device, a notification (e.g., a push notification and/or a newsletter) when a new item of content is published on the newsfeed or when a new smart contract, such as a new content NFT, is offered on the digital marketplace. Additionally, in one or more embodiments, the instructions stored in the memory device, when executed by the processor, cause the processor to display, on the display of the electronic device, a notification (e.g., a push notification) when the members of the DAO have moderated the content on the newsfeed or the content on each block of the blockchain (e.g., when the members of the DAO have voted to remove content from the newsfeed of the social news network). Members of the DAO, including challengers and validators, content providers, etc. may be chosen at random from a pre-vetted pool to participate in the content moderation process to validate content on each block of the blockchain and reward content moderators such as challengers/validators. There may be proof of work aspects on a proof of stake chain and vice versa.

In one or more embodiments, the instructions stored in the memory device, when executed by the processor, cause the processor to analyze the content of the item (e.g., article, image, video, and/or audio file) for display on the newsfeed and/or the smart contracts (such as NFTs) offered in the marketplace to prevent (or at least mitigate) the dissemination of disinformation. For instance, in one or more embodiments, the instructions stored in the memory device, when executed by the processor, cause the processor to apply the bias detection model (described above) to the content of the news items and/or the NFTs to determine the degree of objectivity and/or the degree of bias of the news items and/or the NFTs (i.e., the bias score of each of item of content and/or each NFT). In one or more embodiments, the instructions stored in the memory device, when executed by the processor, cause the processor to apply the claim detection model (described above) to the to the content of the news items and/or the NFTs to determine the degree of claimy-ness of the news items and/or the NFTs (i.e., the claim score of each of the news items and/or the NFTs). In one or more embodiments, the instructions stored in the memory device, when executed by the processor, cause the processor to apply the hate speech detection model (described above) to the news items and/or NFTs to determine the degree of hate speech in the news items and/or the NFTs (i.e., the hate score of each of the news items and/or the NFTs). Additionally, in one or more embodiments, the instructions stored in the memory device, when executed by the processor, cause the processor to apply the summarizer model (described above) to the content of the news items and/or the NFTs to produce a summary, consensus, or any other suitable type of algorithmic data on any of the news items and/or the NFTs. In one or more embodiments, the content of smart contracts may be utilized to fractionalize the NFTs (i.e., to parse the NFTs into components and to offer the individual components or a collection of randomized components and associated hex codes as NFTs on the digital marketplace).

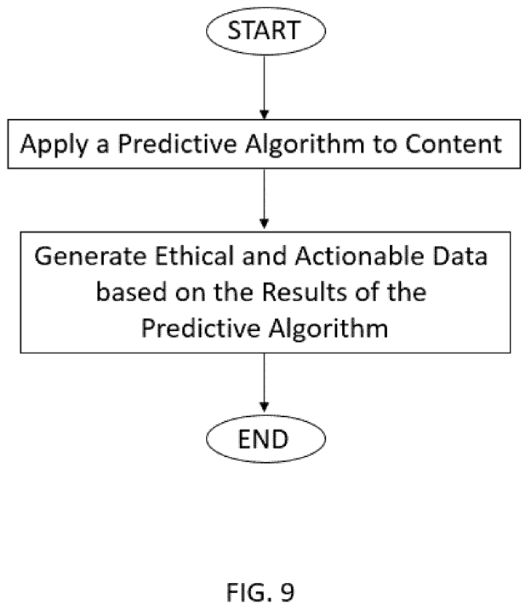

In one or more embodiments, the instructions stored in the memory device, when executed by the processor, cause the processor to apply a predictive algorithm to the content of the news items and/or the NFTs. In one or more embodiments, the predictive algorithm may be an artificial intelligence (Al) natural language processing (NLP) algorithm that is configured to generate ethical and actionable insights and/or data for individuals or businesses (e.g., financial institutions or publishers) from the content of the news items and/or the NFTs. This actionable data may enable businesses to return higher alphas (i.e., higher amounts that the investment has returned compared to the market index or other broad industry benchmark), better Sharpe ratios (i.e., the average return minus the risk-free return divided by the standard deviation of return on an investment), and/or improvements to any other risk adjusted financial measurement. This actionable data may include information regarding trends in a variety of categories, such as cryptocurrencies, traditional equities/securities, healthcare, technology, entertainment, sports, social media insights and trends, real estate, travel, among any other reason-based predictor of future behavior. FIG. 9 is a flowchart illustrating a task of applying a predictive algorithm (e.g., Al NLP algorithm) to the content of the news item and/or the NFT, and a task of generating (e.g., outputting) ethical and actionable data, based on the results of the predictive algorithm, that are designed to increase financial performance.

In one or more embodiments, the instructions stored in the memory device, when executed by the processor, cause the processor to perform a thematic sentiment analysis of the content of the news items and/or the NFTs for markets, companies, and/or publicly traded assets. For instance, in one or more embodiments, the instructions may include an intelligent cryptocurrency coin or token algorithm (or algorithms) that turns text from crypto content on the social news network into actionable, highest quality (i.e., trusted) data, through thematic sentiment analysis and any other analytics using things such as the on-chain metrics, the price, buyers/sellers, relevant Twitter or Reddit (among other social platforms) trending content or account content, among other data that drives investment decisions. In one or more embodiments, the algorithm may be able to identify content on other social platforms and feeds and determine (e.g., identify) actionable data from content on third party platforms. This may include NLP techniques to seek alpha from sentiment analysis of crypto trading, public equities, or markets relating to content sections on the system which is limiting disinformation.

In one or more embodiments, the instructions stored in the memory device, when executed by the processor, cause the processor to perform or generate predictive analytics for content in the metaverse, sentiment analysis based portfolios, environmental, social, and governance (ESG) insight for risk management from leading ESG publications, among other topics.

Accordingly, live inputs from publications on the social news network can turn identifying risk into a premium advantage for businesses or advertisers. For instance, real-time news inputs using macro trends may be utilized to generate higher returns, positive skew, and lower drawdowns. In this manner, the predictive algorithms of the present disclosure may be utilized by companies to increase their assets under management (AUM).

In one or more embodiments, the instructions stored in the memory device, when executed by the processor, cause the processor to display a portal for companies on the social news network to view graphs and analytical data, such as news, subscriber, or newsletter insights, that move markets of any kind using positive/negative sentiment analysis and thematic sentiment to identify trends.

In one or more embodiments, the instructions stored in the memory device, when executed by the processor, may cause the processor to utilize Web3 technology to verify the content for publication on the newsfeed or the smart contract (such as an NFT) for sale on the digital marketplace or placement on the blockchain (e.g., images) coming from publishers or creators by associating the publisher's or the creator's challenger/validator node (e.g., digital ID) on the blockchain with the content (e.g., images, articles, video, or audio). In one or more embodiments, different types of content may be located on different types of nodes or sub-chains of the blockchain. In one or more embodiments, the instructions stored in the memory device, when executed by the processor, may cause the processor to utilize one or more application programming interfaces (APIs) from other platforms to verify the content. In this manner, the system is configured to prohibit or at least mitigate against the proliferation of disinformation on the newsfeed and the digital marketplace.

In one or more embodiments, the platform coins/tokens and the content (e.g., the content for the newsfeed or the smart contracts, such as NFTs, for sale on the digital marketplace) may be associated with different blockchains. Associating the platform coins/tokens and the content with different blockchains may enable the creation and sharing of more items of content than the total number of available platform coins (e.g., the newsfeed and/or the digital marketplace may display more than 21 million articles, pictures, videos, and audio files). In one or more embodiments, the platform coin will be derived from the platform chain with the content from the social news network on it. In one or more embodiments, the number of coins may not limit the amount of content on the platform chain. For example, in one or more embodiments, the platform coins can be fractionalized and allow for an infinite number of content to be stored on the nodes of the dapplication associated with the primary platform chain containing 21 million coins. Additionally, in one or more embodiments, other sub-chains or sub-nodes may be created to increase the capacity for additional content and/or to organize the content via specialization.

In one or more embodiments, the instructions stored in the memory device, when executed by the processor, cause the processor to transfer ownership of at least one NFT and to store the ownership information of the whole NFT or a parsed NFT in a new block in the blockchain. In one or more embodiments, the instructions may transfer ownership of the NFT by executing code in a smart contract associated with the NFT.

In one or more embodiments, the instructions stored in the memory device, when executed by the processor, cause the processor to utilize an NFT publishing standard (e.g., ERC-721) that implements an API for tokens within smart contracts to provide various functionality, such as transferring tokens from one publisher/creator account to another, determining the current token balance of a publisher/creator account, determining the owner of a specific token, determining the total supply of tokens available on the network, and approving than an amount of tokens can be moved from a publisher/creator account to a third party.

The present disclosure also relates to various tasks of a method of addressing disinformation in news. In the illustrated embodiment, the method includes a task of displaying, on a display of an electronic device (e.g., a computer, such as a desktop computer, a laptop computer, or a tablet computer; a smart phone; or a wearable electronic device, such as a smart watch, smart glasses, smart contacts, augmented reality (AR) goggles or glasses, a virtual reality (VR) headset, or immersive technology), a series of news items (e.g., articles, images, video, and/or audio files) on a newsfeed of a social news network. The news items are provided (e.g., created) from one or more publishers and/or content creators.

The method also includes a task of connecting a series of digital wallets of publishers (e.g., news organizations) or creators to a digital marketplace of a social network. Each of the digital wallets includes at least one smart contract, such as a non-fungible token (NFT). The NFTs may include one or more images (e.g., one or more newspaper covers), videos, and/or audio files. In one or more embodiments, hot wallets and/or cold wallets may be used, including hardware wallets (e.g., Trezor™ or Ledger™).

In the illustrated embodiment, the method includes a task of displaying, on the display of the electronic device, the NFTs on the digital marketplace. In this manner, the NFTs may be sold or traded.

In one or more embodiments, the news items displayed on the newsfeed and the smart contracts (e.g., NFTs) displayed on the digital marketplace are limited to those news items and NFTs from creators/publishers that have received prior authorization (i.e., the task includes restricting the electronic device from displaying the news items and the NFTs from the one or more publishers to the newsfeed or the digital marketplace, respectively, without prior authorization). For instance, in one or more embodiments, the task includes displaying news items and NFTs only from a white list of publishers (e.g., a white list of news organizations, such as organizations having reliable journalism credentials and/or reputable national or international news organizations). In one or more embodiments, the NFTs displayed in the digital marketplace may be only from the same data providers that are permitted to post content on the newsfeed. In one or more embodiments, only those news items and NFTs that are approved by members of a decentralized autonomous organization (DAO) or that are created by members of the DAO may be posted to the newsfeed or the digital marketplace.

In the illustrated embodiment, the method also includes a task of sending a notification (e.g., a push notification) to the electronic device in response to a new news item or a new NFT being displayed on the digital marketplace. In one or more embodiments, this task includes sending a notification in response to a news item and/or an NFT being moderated (e.g., removed from the newsfeed or the digital marketplace) by the members of the DAO.

Additionally, in one or more embodiments, the method may include a task of analyzing the content of the news items on the newsfeed and the NFTs offered in the marketplace. For instance, in one or more embodiments, the task may include applying the bias detection model (described above) to the news items and the NFTs to determine the degree of objectivity and/or the degree of bias of the news items and the NFTs (i.e., the bias score of each of the news items and the NFTs), applying the claim detection model (described above) to the news items and the NFTs to determine the degree of claimy-ness of the news items and the NFTs (i.e., the claim score of each of the news items and the NFTs), applying the hate speech detection model (described above) to the news items and the NFTs to determine the degree of hate speech in the news items and the NFTs (i.e., the hate score of each of the news items and the NFTs), applying the summarizer (described above) to the news items and the NFTs, and/or applying the content related algorithms (thematic sentiment analysis) to the news items and NFTs. Consensus algorithms may be used to identify ground truth in articles, stemming from natural language processing (NLP) and sentiment analysis of data coming from the content providers.

In one or more embodiment, the method may also include a task of transferring ownership of at least one NFT and to store the ownership information of the NFT in a new block in the blockchain. In one or more embodiments, the task may transfer ownership of the NFT by executing code in a smart contract associated with the NFT.

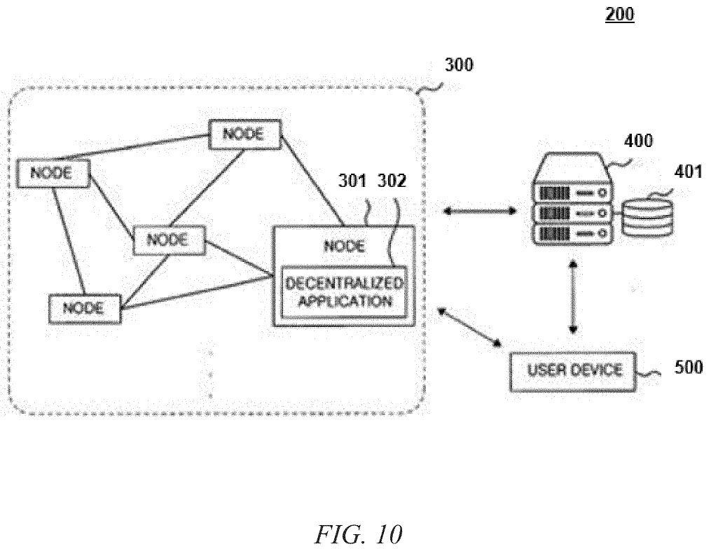

FIG. 10 is a schematic block diagram of a decentralized system 200 for creating, sharing, and moderating content on a social news network according to one embodiment of the present disclosure. In the illustrated embodiment, the decentralized system 200 includes a distributed peer-to-peer (P2P) blockchain-based network 300 including a series of nodes 301 that store a decentralized digital ledger that records all cryptocurrency transactions on the blockchain. All of the nodes 301 are connected to each other and exchange the latest blockchain data with each other such that each of the nodes 301 are updated. Additionally, in the illustrated embodiment, each of the nodes 301 connects to a decentralized application (“dApp”) 302. In one or more embodiments, each of the nodes 301 may be associated with a publisher or content creator (e.g., validators/challengers). Additionally, in one or more embodiments, one or more of the nodes 301 may include one or more sub-nodes. The decentralized system 300 also includes a user device 400 and a server 500 including a database 501. The user device 300 and the server 400 are in communication with each other and with the distributed P2P blockchain-based network 200. In one or more embodiments, the dApp is configured to display the social news network described above including a newsfeed that displays a variety of news items or other content (e.g., articles, audio files, video files, and/or pictures) from the publishers or content creators associated with the nodes.

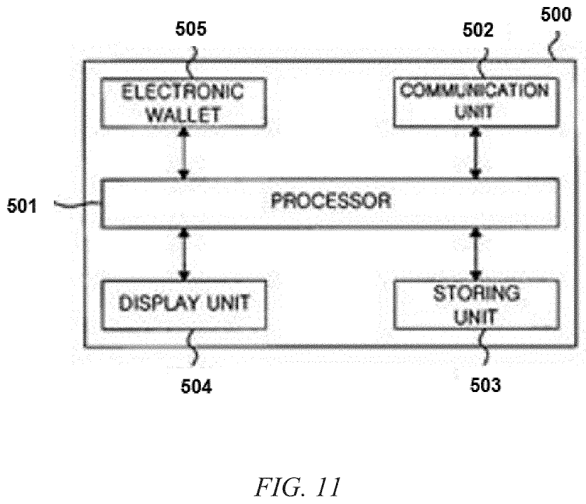

With reference now to FIG. 11, the user device 500 according to one embodiment includes a processor 501, a network adapter or communication unit 502 configured to enable communication with the server 400 and the distributed P2P blockchain-based network 300, a memory device (storing unit) 503, a display unit 504, and an electronic wallet 505. The electronic wallet 305 may be contained on the user device 500 or otherwise connected to or associated with the user device 500. The display 504 is configured to display the dApp 302 stored in the nodes 301 of the distributed P2P blockchain-based network 300. In one or more embodiments, the dApp 302 is configured to display the data feed 104 described above. Additionally, in one or more embodiments, the dApp 302 may be configured to display the results of the algorithms described above, including the bias detection model, the claim detection model, the hate speech detection model, the summarizer, and/or the predictive algorithms.

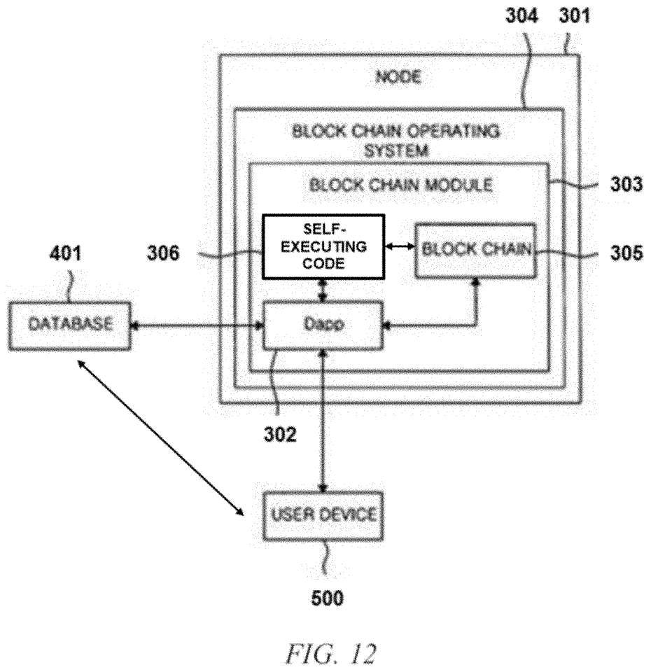

FIG. 12 is a schematic block diagram of one of the nodes 301 of the decentralized P2P proof of stake blockchain network 200 depicted in FIG. 10. In the illustrated embodiment, each of the nodes 301 includes a block chain module 303 running within a block chain operating system 304. The dApp 302 is connected to the block chain 305 and a smart contract module 306 within the block chain module 303.

In one or more embodiments, the systems, methods, and processes of the present disclosure may be implemented utilizing the P2P blockchain-based network 200, the user device 300, and the server 400 illustrated in FIGS. 10-12. The decentralized system 200 depicted in FIG. 10 may be utilized instead of the system 100 depicted in FIG. 1.

Additionally, in FIG. 12 the user device 500 is connected to the database 401, via any suitable wireless protocol, outside of the blockchain. In one or more embodiments, the content may be moderated by the vetted content providers (e.g., journalists) outside of the blockchain before the content is stored in a block on the chain, and/or the content may be moderated by the vetted content providers (e.g., journalists) after the content has been stored in the blockchain.

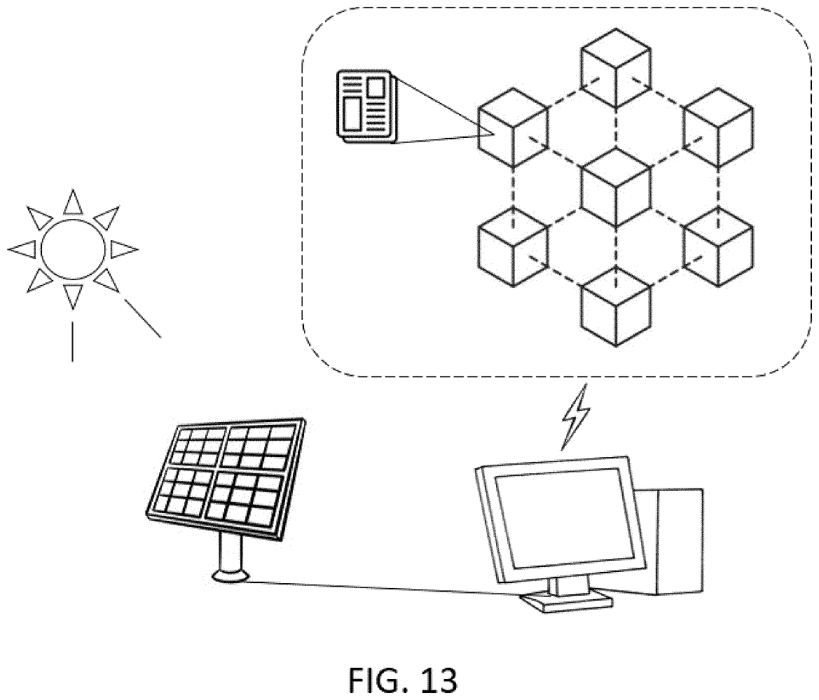

FIG. 13 is a schematic diagram of a decentralized proof of work system according to one embodiment of the present disclosure. In the illustrated embodiment, the decentralized system includes a solar panel configured to generate power (W) from solar energy, although in one or more embodiments, the decentralized system may include any other suitable device for harvesting or generating energy from renewable or sustainable resources. In the illustrated embodiment, the solar panel is connected to a mining ASIC or other suitable computer mining hardware having a suitable hash rate that is configured to mine network coins/tokens (e.g., platform tokens or alternative coins offered by a publisher or a content creator) utilizing the energy generated from the solar panel or other energy harvesting/generating device. In this manner, the mining ASIC is configured to verify new blocks on the blockchain network and thereby moderate (e.g., verify) content (e.g., articles, photos, videos, podcasts, radio, etc.) on the nodes or sub-nodes of the blockchain network.

The terminology used herein is for the purpose of describing particular example embodiments only and is not intended to limit the example embodiments described herein.

As used herein, the singular forms “a,” “an,” and “the” are intended to include the plural forms as well, unless the context clearly indicates otherwise.

It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “and/or” includes any and all combinations of one or more of the associated listed items.

Further, the use of “may” when describing embodiments of the present disclosure refers to “one or more embodiments of the present disclosure”.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, and equivalents thereof.

What is claimed is:

1. A decentralized system for addressing disinformation in news, the decentralized system comprising:
a plurality of nodes connected over a distributed peer-to-peer blockchain-based network;
a non-transitory computer-readable storage medium of at least one node of the plurality of nodes having software instructions stored therein, which, when executed by a processor of the at least one node, cause the processor to:
display, on a display of an electronic device, a newsfeed comprising a plurality of news items received from one or more publishers; and
moderate the content displayed on the display of the electronic device in response to a vote by members of a decentralized autonomous organization (DAO), wherein the members of the DAO comprise the one or more publishers.

2. The decentralized system of claim 1, wherein the software instructions, when executed by the processor, further cause the processor to:
display, on a display of an electronic device, a digital marketplace comprising a plurality of non-fungible tokens (NFTs) stored in digital wallets associated with the one or more publishers; and
restrict the electronic device from displaying the NFTs on the digital marketplace without prior authorization.

3. The decentralized system of claim 2, wherein the instructions, when executed by the processor, further cause the processor to transfer ownership of at least one NFT and to store the ownership of the NFT in a new block in the blockchain.

4. The decentralized system of claim 3, wherein the instruction, when executed by the processor, cause the processor to transfer the ownership of the NFT by executing code in a smart contract associated with the NFT.

5. The decentralized system of claim 1, wherein at least one publisher of the one or more publishers is a news organization.

6. The decentralized system of claim 1, wherein the news items are selected from a group consisting of an image, a video, and an audio file.

7. The decentralized system of claim 6, wherein the image is a newspaper cover.

8. The decentralized system of claim 1, wherein the instructions, when executed by the processor, further cause the processor to display, on the display of the electronic device, the news items received only from a white list of news organizations.

9. The decentralized system of claim 1, wherein the instructions, when executed by the processor, further cause the processor to send a notification, to the electronic device, in response to a new news item being published by a publisher on the newsfeed.

10. The decentralized system of claim 1, wherein the software instructions, when executed by the processor, further cause the processor to display, on the display of the electronic device, a content feed comprising a plurality of news items received from the one or more news organizations.

11. The decentralized system of claim 1, wherein the software instructions, when executed by the processor, further cause the processor to analyze content of at least one news item to determine at least one of a bias score, a claim score, and a hate speech score.

12. The decentralized system of claim 1, further comprising:
a mining application specific integrated circuit (ASIC) configured to mine coins; and
a renewable or sustainable power source configured to power the mining ASIC.

13. The decentralized system of claim 1, wherein the newsfeed is configured not to display content based on user engagement with the content on the newsfeed.

14. The decentralized system of claim 1, wherein the decentralized system is configured to display, on the display of the electronic device, a metaverse.

15. The decentralized system of claim 14, wherein the metaverse includes at least one digital asset selected from the group selected from the group consisting of a digital marketplace, a digital newsstand, a mining portal, and a minting portal.

16. The decentralized system of claim 1, wherein the decentralized system is configured to enable subscription to a business page and advertising through a portal.

17. The decentralized system of claim 1, wherein the software instructions, when executed by the processor of the at least one node, further cause the processor to apply a predictive algorithm to at least one news item of the plurality of news items displayed on the newsfeed.

18. A method comprising:
displaying, on a display of an electronic device, a newsfeed comprising a plurality of news items received from one or more publishers; and
moderating the content displayed on the display of the electronic device in response to a vote by members of a decentralized autonomous organization (DAO), wherein the members of the DAO comprise the one or more publishers.

19. The method of claim 18, further comprising:
connecting a plurality of digital wallets of a plurality of news organizations to a social network, each digital wallet comprising a non-fungible token (NFT);
displaying, on a display of an electronic device, a digital marketplace comprising a plurality of non-fungible tokens (NFTs) stored in digital wallets of one or more publishers; and
restricting the electronic device from displaying the NFTs from the one or more publishers to the digital marketplace without prior authorization.

20. The method of claim 19, further comprising transferring ownership of at least one NFT and storing the ownership of the at least one NFT in a new block in the blockchain.

21. The method of claim 20, further comprising transferring the ownership of the NFT by executing code in a smart contract associated with the NFT.

22. The method of claim 18, wherein at least one publisher of the one or more publishers is a news organization.

23. The method of claim 18, wherein the news items are selected from a group consisting of an image, a video, and an audio file.

24. The method of claim 23, wherein the image is a newspaper cover.

25. The method of claim 18, wherein the instructions, when executed by the processor, further cause the processor to display, on the display of the electronic device, the news items received only from a white list of news organizations.

26. The method of claim 18, further comprising sending a notification, to the electronic device, in response to a new news item being published by a publisher on the newsfeed.

27. The method of claim 18, further comprising analyzing content of at least one news item to detect at least one of bias, claimy-ness, and hate speech.
